(19) United States
(12) Patent Application Publication
(10) Pub. No.: US 2010/0192214 A1
(43) Pub. Date: Jul. 29, 2010

(54) INFORMATION PROCESSING APPARATUS, INFORMATION PROCESSING METHOD, AND RECORDING MEDIUM INCLUDING COMPUTER PROGRAM

(75) Inventors: Takashi OHNO, Kawasaki (JP); Ryuichi Matsukura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/691,060

(22) Filed: Jan. 21, 2010

(30) Foreign Application Priority Data
Jan. 29, 2009 (JP) 2009-018557

(51) Int. Cl. H04L 9/32

(52) U.S. Cl. 726/8

(57) ABSTRACT

An information processing method includes receiving user information from a input unit pre-corresponded to the executer; acquiring the received user information via the corresponded input unit; determining whether the acquired user information matches the user information of the pre-corresponded user; starting a standard operation when the acquired user information is determined to match the user information of the pre-corresponded user; requesting the controller to identify another executer corresponded to the acquired user information when the acquired user information is determined to fail to match the user information of the pre-corresponded user; identifying the other executer corresponded to the user information when the executer requests the other executer corresponded to the user to be identified; and switching between the input unit corresponded to the executer having requested the other executer to be identified and the input unit corresponded to the other executer when the other executer is identified.

### CROSS-REFERENCE TO RELATED APPLICATIONS

This application is based upon and claims the benefit of priority of the prior Japanese Patent Application No. 2009-018557, filed on Jan. 29, 2009, the entire contents of which are incorporated herein by reference.

### FIELD

Various embodiments described herein to an information processing apparatus, an information processing method, and a recording medium including a computer program, related to a virtual technique that allows a single apparatus to operate virtually as a plurality of apparatuses.

### BACKGROUND

Personal computers have been in widespread use recently. Each user has typically their own computer. As performance of a hardware element such as a central processing unit (CPU) mounted on the computer is enhanced, the performance of the computer is substantially enhanced. Depending on the workload on the computer, the computer has extra power to spare if the computer is used by a single person.

The virtual machine (VM) technique draws attention as a means to fully exploit the performance of computer. The virtual machine technique is a technique that partitions a single computer into a plurality of computers (virtual machines) that operate virtually and independently. If a single computer operates as a plurality of virtual machines, that computer can be used by a plurality of users.

The computer, having extra power to spare if used by a single person, is fully exploited. Since it is unnecessary to prepare one computer per user, otherwise necessary spaces for the computer are eliminated. Computer power consumption is also reduced. Since a single computer is used by a plurality of users, the user usage environments are made integrated. Centrally controlling the computer helps reduce maintenance costs.

Personal computers with a plurality of ports including a universal serial bus (USB) port and a port to be connected to a display are currently commercially available. Such a personal computer can be connected via USB cables to a plurality of input devices including a mouse and a keyboard. The personal computer can also be connected to a plurality of output devices, such as a display, via display cables.

If the virtual machine technique is applied to a personal computer having a plurality of ports, a plurality of user operation environments are implemented on the single personal computer (as disclosed in Japanese Patent No. 3206247, Japanese Laid-open Patent Publication No. 2002-318699, and Japanese Laid-open Patent Publication No. 2000-259300). More specifically, a single personal computer connects to input-output device sets of the number equal to the number of users. Each input-output device set may include a mouse, a keyboard, a display, etc. Using one of the input-output device sets, each user uses the virtual machine arranged in the personal computer.

In such a usage environment, a single personal computer is shared by a plurality of users, who use the respective input-output device sets within the reach of connection cables. For example, such a system is effective at a home where a single computer may be shared by a plurality of family members, or at an office where a single computer is shared by a plurality of office workers.

Also, this technique is disclosed in Japanese Patent No. 3206247, Japanese Laid-open Patent Publication No. 2002-318699, and Japanese Laid-open Patent Publication No. 2000-259300.

### SUMMARY

An aspect of the present invention is an information processing apparatus includes a plurality of executers executing a variety of processes; a controller controlling operation of each of the plurality of executers; and a user mapping storage unit that stores correspondence between user information and users respectively corresponded to the executers, wherein each executer includes a user information storage unit that stores first user information of a user pre-corresponded to the executer; an input receiving unit that receives second user information from an input unit pre-corresponded to the executer; a user information acquisition unit that acquires, via the corresponded input unit, the second user information received by the input receiving unit; a determiner that determines whether the second user information acquired by the user information acquisition unit matches the first user information stored in the user information storage unit; an operation starting unit that starts a standard operation when the determiner has determined that the second user information acquired by the user information acquisition unit matches the first user information stored in the user information storage unit; and an identification requesting unit that requests the controller to identify another executer corresponded to the second user information acquired by the user information acquisition unit when the determiner has determined that the second user information acquired by the user information acquisition unit fails to match the first user information stored in the user information storage unit, and wherein the controller includes an identifying unit that identifies the other executer corresponded to the second user information in accordance with the correspondence stored in the user mapping storage unit when the executer has requested the controller to identify the other executer corresponded to the second user information; and an interchanging unit that interchanges between the input unit corresponded to the executer having requested the other executer to be identified and the input unit corresponded to the other executer when the identifying unit has identified the other executer.

The object and advantages of the various embodiments will be realized and attained by means of the elements and combinations particularly pointed out in the claims.

It is to be understood that both the foregoing general description and the following detailed description are exemplary and explanatory and are not restrictive of the various embodiments, as claimed.

### BRIEF DESCRIPTION OF DRAWINGS

FIG. 1 illustrates the structure of a personal computer (PC) of a first embodiment.

FIG. 2 illustrates the structure of the PC of the first embodiment.

FIGS. 3A-3D illustrate stored contents in each table.

FIG. 4 is a functional block diagram of the PC of the first embodiment.

FIG. 5 is a functional block diagram of the PC of the first embodiment.

FIG. 6 illustrates a display screen of a monitor.

FIGS. 7A-7C illustrate operation of the PC of the first embodiment.

FIG. 8 is a flowchart of a process of a central processing unit (CPU) performed at the power-on of the PC.

FIG. 9 is a flowchart of a user authentication process.

FIG. 10 is a flowchart of a user authentication process.

FIG. 11 is a flowchart of a user authentication process.

FIG. 12 is a flowchart of an ending process performed by a virtual machine (VM).

FIG. 13 illustrates stored contents in a history information table.

FIG. 14 is a functional block diagram of a PC in accordance with a second embodiment.

FIG. 15 is a flowchart of a process performed by the CPU at the power-on of the PC.

FIG. 16 is a flowchart of a process performed by the CPU at the power-on of the PC.

FIG. 17 illustrates stored contents listed in a device mapping table.

FIG. 18 is a functional block diagram of a PC of a third embodiment.

FIG. 19 is a flowchart of a user authentication process.

FIG. 20 is a flowchart of a user authentication process.

FIG. 21 is a flowchart of a user authentication process.

FIG. 22 is a flowchart of a process performed by a virtual machine monitor (VMM) when the VM ends the operation thereof in a desktop UI mode.

FIG. 23 is a functional block diagram of a PC of a fourth embodiment.

FIG. 24 is a flowchart of a user authentication process.

FIG. 25 is a functional block diagram of a PC of a fifth embodiment.

FIG. 26 is a flowchart of a user authentication process.

FIG. 27 is a flowchart of a user authentication process.

FIG. 28 is a flowchart of a user authentication process.

FIG. 29 illustrates a display screen of a monitor in accordance with a sixth embodiment.

### DESCRIPTION OF EMBODIMENTS

An information processing apparatus, an information processing method, and a recording medium including a computer program of the embodiments are described in detail below. In each of the embodiments, the information processing apparatus disclosed herein is applied to a personal computer (PC) as described below.

### First Embodiment

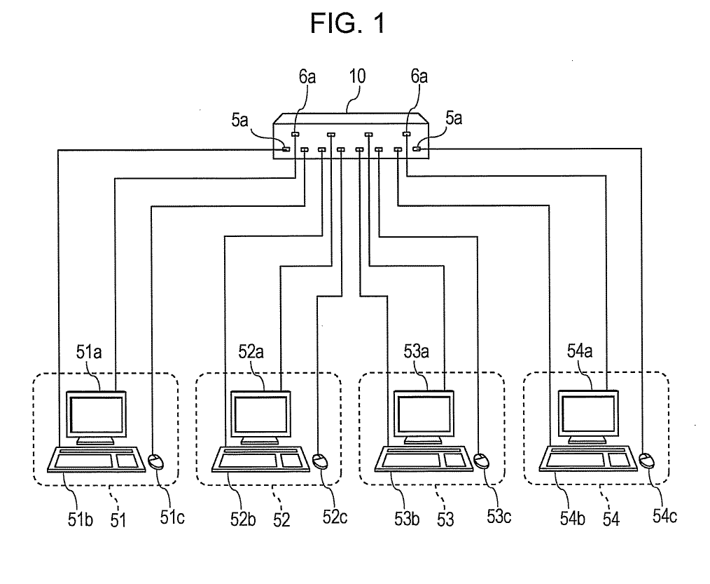

A personal computer (PC) 10 of a first embodiment is described below. FIG. 1 illustrates the structure of the PC 10 of the first embodiment. The PC 10 of the first embodiment includes on the casing thereof eight USB ports 5a and four monitor connection ports 6a. Referring to FIG. 1, the eight USB ports 5a are horizontally arranged on the lower side of the side panel of the PC 10 and the four monitor connection ports 6a are horizontally arranged above the USB ports 5a.

Four keyboards 51b, 52b, 53b, and 54b and four mouses 51c, 52c, 53c, and 54c are respectively connected to the PC 10 of the first embodiment via USB cables connected to the USB ports 5a. Four monitors 51a, 52a, 53a, and 54a are connected to the PC 10 of the first embodiment via monitor connection cables connected to the monitor connection ports 6a.

The PC 10 of the first embodiment can connect to four input-output device sets 51, 52, 53, and 54. The input-output device sets 51, 52, 53, and 54 include, respectively, the monitors 51a, 52a, 53a, and 54a, the keyboards 51b, 52b, 53b, and 54b, and the mouses 51c, 52c, 53c, and 54c. The PC which the information processing apparatus of the embodiments is applicable to is not limited to the one having the above-described structure. The number of USB ports 5a is not limited to eight, and the number of monitor connection ports 6a is not limited to four. A USB hub may be connected to a single USB port, and a plurality of keyboards and a plurality of mouses are connected to a PC 10 via the USB hub. The information processing apparatus disclosed herein is also applicable to such a PC.

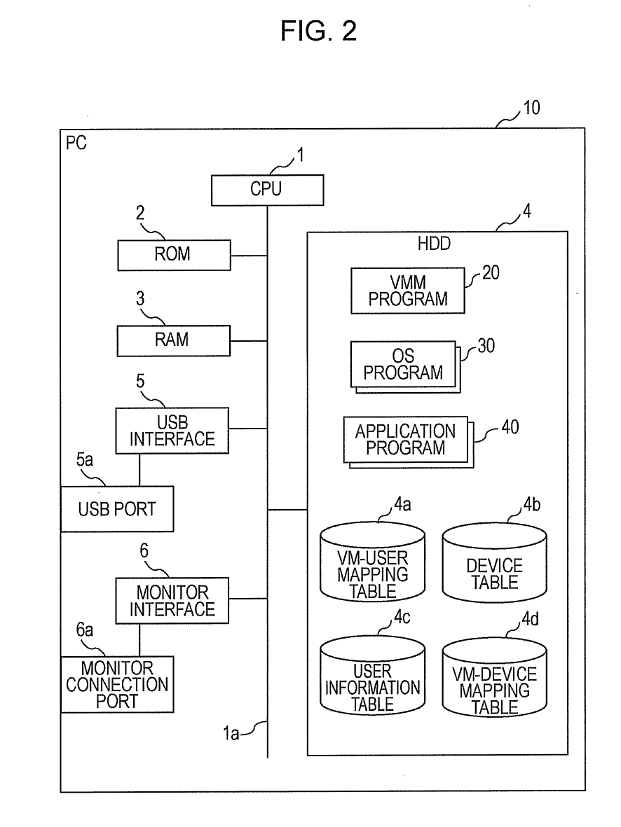

FIG. 2 illustrates the structure of the PC 10 of the first embodiment. The PC 10 of the first embodiment includes, as hardware elements, central processing unit (CPU) 1, read-only memory (ROM) 2, random-access memory (RAM) 3, hard disk drive (HDD) 4, USB interface 5, monitor interface 6, etc. The hardware elements are interconnected to each other via a bus 1a.

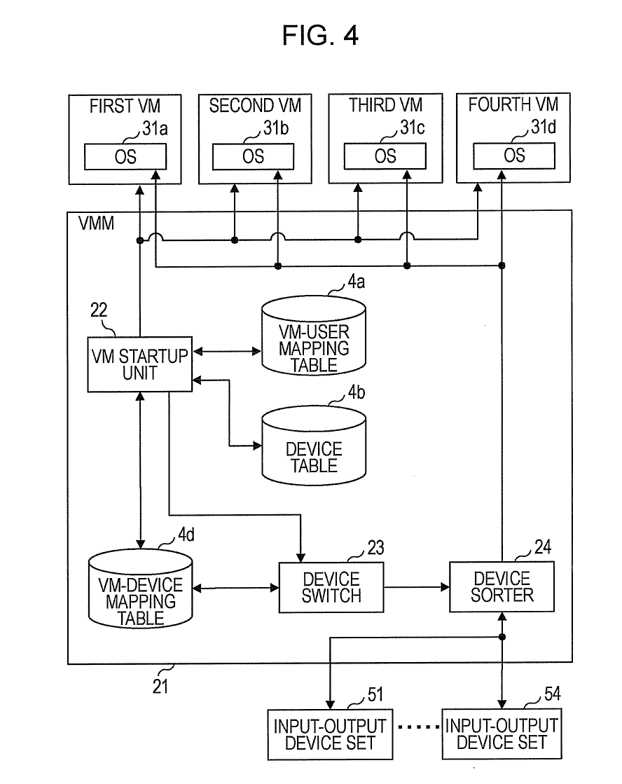

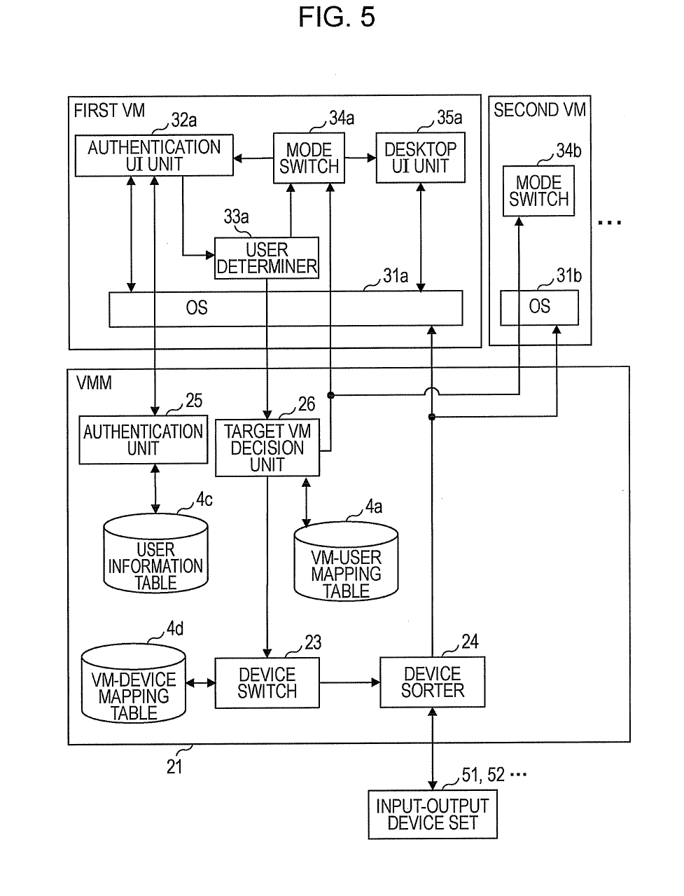

The CPU 1 reads a control program from the ROM 2 or the HDD 4 onto the RAM 3 and executes the read control program as necessary, and controls the operation of each of the above-described hardware elements. The CPU 1 reads a virtual machine monitor (VMM) program 20 and an operating system (OS) program 30 from the HDD 4 onto the RAM 3 and executes the programs 20 and 30. The PC 10 thus functions as a VMM 21 and OS's 31a, 31b, 31c, and 31d (see FIGS. 4 and 5). The CPU 1, if operating as the VMM 21, also operates logically as a plurality of CPUs. If a multi-core CPU is used for the CPU 1, the VMM 21, the OS's 31a, 31b, 31c, and 31d are distributed and operated on physically different CPU cores. Alternatively, it would be perfectly acceptable to use a single core CPU for the CPU 1.

The ROM 2 pre-stores a variety of control programs for causing the PC 10 to operate as the information processing apparatus disclosed herein. The RAM 3 may be a static RAM (SRAM), a dynamic RAM (DRAM), a flash memory, or the like. The RAM 3 temporarily stores a variety of data generated in the course of execution of the control program by the CPU 1.

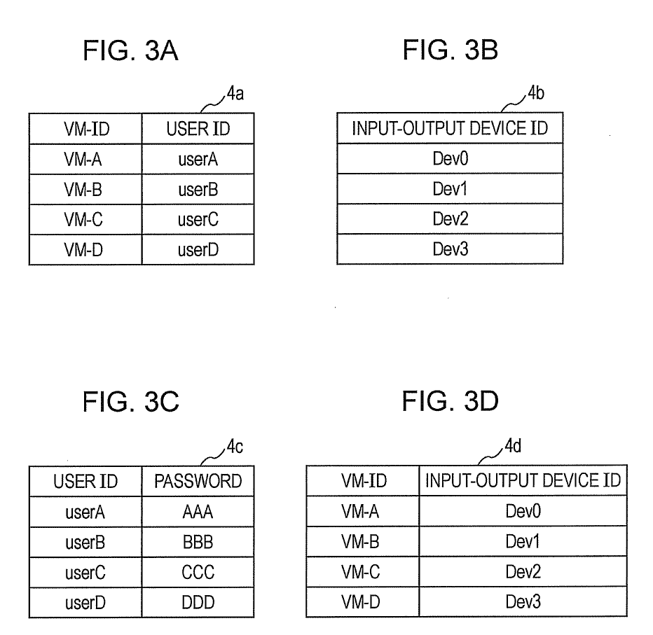

The HDD 4 is a high-volume storage device. The HDD 4 stores a variety of control programs for causing the PC 10 to operate as the information processing apparatus disclosed herein. The HDD 4 also stores data including a VM-user mapping table 4a illustrated in FIG. 3A, a device table 4b illustrated in FIG. 3B, a user information table 4c illustrated in FIG. 3C, and a VM-device mapping table 4d illustrated in FIG. 3D. The HDD 4 further stores, as the control program to be read and executed by the CPU 1, the VMM program 20, the four OS programs 30, an application program 40, etc.

The USB interface 5 connects to the eight USB ports 5a. The USB interface 5 exchanges data with devices connected thereto via the USB cables respectively connected to the USB ports 5a. The USB interface 5 of the first embodiment connects to the keyboards 51b, 52b, 53b, and 54b, and the mouses 51c, 52c, 53c, and 54c via the USB cables. The USB interface 5 thus exchanges data with the keyboards 51b, 52b, 53b, and 54b, and the mouses 51c, 52c, 53c, and 54c.

Each of the keyboards 51b, 52b, 53b, and 54b, and the mouses 51c, 52c, 53c, and 54c includes a variety of operation keys allowing a user to operate the PC 10 and a movement detector, and the like. When each operation key is operated by the user, each of the keyboards 51b, 52b, 53b, and 54b, and the mouses 51c, 52c, 53c, and 54c sends to the respective OS's 31a, 31b, 31c, and 31d a control signal responsive to the operated key. The OS's 31a, 31b, 31c, and 31d perform processes responsive to the control signal acquired from the keyboards 51b, 52b, 53b, and 54b, and the mouses 51c, 52c, 53c, and 54c.

The monitor interface 6 connects to the four monitor connection ports 6a. The monitor interface 6 of the first embodiment connects to the monitors 51a, 52a, 53a, and 54a via the monitor connection cables respectively connected to the monitor connection ports 6a. The monitor interface 6 thus exchanges data with the monitors 51a, 52a, 53a, and 54a.

Each of the monitors 51a, 52a, 53a, and 54a may be a liquid-crystal display, a cathode-ray tube (CRT), or the like. In accordance with data sent via the monitor interface 6 from the corresponding OS's 31a, 31b, 31c, and 31d, the monitors 51a, 52a, 53a, and 54a display an operational status of the PC 10 (VM), information input by each user, information which the user is to be notified of, and other information.

FIG. 3A illustrates stored contents in the VM-user mapping table 4a. FIG. 3B illustrates stored contents in the device table 4b. FIG. 3C illustrates stored contents in the user information table. FIG. 4D illustrates stored contents in the VM-device mapping table 4d.

Referring to FIG. 3A, the VM-user mapping table 4a (user mapping table) corresponds between VM-ID (virtual machine identification) and a user ID. The VM-ID is an identifier identifying a VM. The VM is constructed when the CPU 1 executes the OS program 30. The user ID is an identifier identifying a user each VM is assigned to. The stored content on the VM-user mapping table 4a is registered at the initial setting process of the PC 10. The PC 10 can be used only by a user identified by a user ID stored in the VM-user mapping table 4a. Each VM stores on the RAM 3 or the HDD 4, assigned thereto, the user ID of the user assigned thereto, and a variety of setting information and the like, set by the user.

Referring to FIG. 3B, the device table 4b stores input-output device IDs respectively assigned to all the input-output device sets 51, 52, 53, and 54 connected to the PC 10. The stored content on the device table 4b is registered on the PC 10 at an initial setting process of the PC 10. The input-output device set 51 (52, 53, or 54) includes the monitor 51a (52a, 53a, or 54a), the keyboard 51b (52b, 53b, or 54b), and the mouse 51c (52c, 53c, or 54c), respectively.

Referring to FIG. 3C, the user information table 4c (authentication information storage unit) corresponds between the user ID of a user who is authorized to use the PC 10, and a password (authentication information) pre-registered by the user. The stored content on the user information table 4c is registered at the initial setting process of the PC 10. The stored content on the user information table 4c is also updated by the corresponding one of the OS's 31a, 31b, 31c, and 31d if the user changes their own password during the use of own VM.

Referring to FIG. 3D, the VM-device mapping table 4d corresponds between the VM-ID of a VM, and the input-output device ID indicating one of the input-output device sets 51, 52, 53, and 54 corresponded to the VM. The VMM 21 registers the stored content on the VM-device mapping table 4d each time the VMM 21 corresponds the OS's 31a, 31b, 31c, and 31d to the input-output device sets 51, 52, 53, and 54, respectively when the VMM 21 starts the OS's 31a, 31b, 31c, and 31d. Furthermore, the stored content on the VM-device mapping table 4d is updated by the VMM 21 each time the VMM 21 updates the correspondence of the OS's 31a, 31b, 31c, and 31d and the input-output device sets 51, 52, 53, and 54.

The process performed when the CPU 1 in the PC 10 executes the control program stored on one of the ROM 2 and the HDD 4 is described below. FIGS. 4 and 5 illustrate functional block diagrams of the PC 10 of the first embodiment. FIGS. 4 and 5 also illustrate the operational principle of the virtual technique on which the PC 10 operates as a plurality of PCs (VMs).

Referring to FIGS. 4 and 5, four VMs (a first VM, a second VM, a third VM, and a fourth VM) operate independently of each other on the PC 10 in response to the operation of the VMM 21. The VMM 21 operates on a hardware structure including the CPU 1, the RAM 3, the HDD 4, the input-output device sets 51, 52, 53, and 54, and the like.

The VMM program 20 is a software program that implements the virtual technique causing a plurality of OS's (four OS's in the first embodiment, namely, the OS's 31a, 31b, 31c, and 31d) to run on the PC 10. The CPU 1 operates as the VMM (virtual machine monitor) 21 by reading the VMM program 20 from the HDD 4, thereby providing a virtual environment where the PC 10 operates logically as a plurality of PCs (the first VM, the second VM, the third VM, and the fourth VM). In this way, the PC 10 operates logically as the four independent virtual machines (VMs).

The VMM 21 (controller) manages each software program and each hardware resource, thereby generally controlling the operation of the hardware elements respectively corresponding to the OS's 31a, 31b, 31c, and 31d. For example, upon starting the OS's 31a, 31b, 31c, and 31d, the VMM 21 assigns the input-output device sets 51, 52, 53, and 54 respectively to the OS's 31a, 31b, 31c, and 31d.

The OS program 30 includes OS software programs, such as a command user interface (CUI) operated by the user, Windows (registered trademark) having graphic user interface (GUI), and Linux, etc. The CPU 1 reads the four OS programs 30 from the respective HDD 4 and executes the OS programs 30. The CPU 1 thus functions as each of the OS's 31a, 31b, 31c, and 31d, thereby functioning as an executer performing each process. The OS's 31a (31b, 31c, or 31d) generates a display screen containing the CUI, the GUI, etc. displayed in response to the process to be performed, and then displays the display screen on the corresponded monitor 51a (52a, 53a, or 54a). The OS's 31a (31b, 31c, or 31d) receives a control signal respectively from the keyboard 51b (52b, 53b, or 54b) and the mouse 51c (52c, 53c, or 54c) and performs a variety of processes in response to the received control signal.

The VMM 21 starts up each of the OS's 31a, 31b, 31c, and 31d by reading and executing the OS program 30 on the HDD 4. The VMM 21 then assigns to the OS's 31a, 31b, 31c, and 31d the hardware structure used by the OS's 31a, 31b, 31c, and 31d, namely, the RAM 3, the HDD 4, and the input-output device sets 51, 52, 53, and 54. The CPU 1 (the VMM) 21 is assigned to, and the OS's 31a, 31b, 31c, and 31d on a per CPU core unit basis.

The CPU 1 reads from the RAM 3 the VMM program 20, the OS program 30, etc, and executes the read programs. The RAM 3 stores temporarily a variety of information when the CPU 1 reads each control program from the RAM 3 and executes the read program. The RAM 3 also stores setting information of each of the OS's 31a, 31b, 31c, and 31d when the CPU 1 operates as each of the OS's 31a, 31b, 31c, and 31d. The RAM 3 is also logically partitioned into a plurality of RAMs by the VMM 21, and the plurality of RAMs are respectively assigned to the VMM 21, and the OS's 31a, 31b, 31c, and 31d.

When the above-described PC 10 is powered on, each hardware element in the PC 10 starts up. The CPU 1 starts the operation of the VMM 21 by executing the VMM program 20. The VMM 21 reads and executes each of the OS programs 30, thereby starting each of the OS's 31a, 31b, 31c, and 31d. The VMM 21 assigns to the OS's 31a, 31b, 31c, and 31d the hardware elements to be used by the OS's 31a, 31b, 31c, and 31d. The virtual environment (the first VM, the second VM, the third VM, and the fourth VM) is thus assigned to the OS's 31a, 31b, 31c, and 31d. The hardware elements assigned to the OS's 31a, 31b, 31c, and 31d include the CPU 1, the RAM 3, the HDD 4, and the input-output device sets 51, 52, 53, and 54, etc.

The VMM 21 has functions of maintaining the operation of each of the OS's 31a, 31b, 31c, and 31d at a normal level. More specifically, the VMM 21 has a function of starting and ending the OS's 31a, 31b, 31c, and 31d, a function of assigning the hardware elements respectively to the OS's 31a, 31b, 31c, and 31d, and a function of causing each of the OS's 31a, 31b, 31c, and 31d to execute an appropriate application program.

The application program 40 is a software program to be executed by each of the OS's 31a, 31b, 31c, and 31d. The PC 10 may read the application program 40 from an external memory (not shown) or via a network (not shown), and store the application program 40 onto the HDD 4.

Depending on modules contained in the VMM program 20, the VMM 21 of the first embodiment has functions of VM startup unit 22, device switch 23, device sorter 24, authentication unit 25, and target VM decision unit 26. Depending on modules contained in the OS program 30, the OS's 31a, 31b, 31c, and 31d of the first embodiment have functions of authentication user interface (UI) units 32a, 32b, 32c, and 32d, user determiners 33a, 33b, 33c, and 33d, mode switches 34a, 34b, 34c, and 34d, and desktop user interface (UI) units 35a, 35b, 35c, and 35d, respectively.

FIGS. 4 and 5 do not illustrate the authentication UI units 32b, 32c, and 32d, the user determiners 33b, 33c, and 33d, the mode switches 34b, 34c, and 34d, and the desktop UI units 35b, 35c, and 35d.

The first VM, the second VM, the third VM, and the fourth VM are also collectively referred to as a VM. The OS's 31a, 31b, 31c, and 31d are also collectively referred to as an OS 31. The authentication UI units 32a, 32b, 32c, and 32d are also collectively referred to as an authentication UI unit 32. The user determiners 33a, 33b, 33c, and 33d are also collectively referred to as a user determiner 33. The mode switches 34a, 34b, 34c, and 34d are also collectively referred to as a mode switch 34. The desktop UI units 35a, 35b, 35c, and 35d are also collectively referred to as a desktop UI unit 35.

The PC 10 is now powered on, causing the CPU 1 to start the VMM 21. The VM startup unit 22 then starts the first VM, the second VM, the third VM, and the fourth VM in response to the stored contents in the VM-user mapping table 4a and the device table 4b. More specifically, the VM startup unit 22 reads the VM-IDs stored on the VM-user mapping table 4a and the input-output device IDs stored on the device table 4b, starting from the top of each table.

The VM startup unit 22 assigns the input-output device set 51 identified by the input-output device ID read from the device table 4b to the VM identified by the VM-ID read from the VM-user mapping table 4a, and starts the first VM, the second VM, the third VM, and the fourth VM. The VM startup unit 22 causes each VM to execute the OS program 30 responsive to the VM-ID read from the VM-user mapping table 4a, thereby starting the OS 31a, the OS 31b, the OS 32c, and the OS 32d. The VM startup unit 22 stores, on the VM-device mapping table 4d, the VM-ID of the started first VM and the input-output device ID of the input-output device set 51 assigned to the first VM, with the VM-ID corresponded to the input-output device ID.

Each user causes a variety of setting information set for the OS 31 to be read at the start of the OS 31. The OS 31 corresponded to each user is thus organized. The setting information contains user information such as a user ID of each user and the like. In response to the user information, the OS 31 learns which user is pre-corresponded thereto.

The VM startup unit 22 starts up the VMs corresponded to all the VM-IDs stored in the VM-user mapping table 4a. The VM startup unit 22 here starts the four VMs and stores onto the VM-device mapping table 4d the VM-IDs of the four VMs and the input-output device IDs of the input-output device sets 51, 52, 53, and 54 respectively assigned to the VMs. Upon starting up all the VMs, the VM startup unit 22 notifies the device switch 23 that all the VMs have been started.

In response to the stored content on the VM-device mapping table 4d, the device switch 23 corresponds between the VMs and the input-output device sets 51, 52, 53, and 54. More specifically, the device switch 23 reads the VM-IDs and the input-output device IDs stored on the VM-device mapping table 4d, starting from the top of the table. The device switch 23 then instructs the device sorter 24 to assign the input-output device sets 51, 52, 53, and 54 identified by the read input-output device IDs to the OS's 31a, 31b, 31c, and 31d responsive to the read VM-IDs.

In response to the instruction from the device switch 23, the device sorter 24 sorts the input-output device sets 51, 52, 53, and 54 to the OS's 31a, 31b, 31c, and 31d, respectively. More specifically, the device sorter 24 sends input information from the input-output device sets 51, 52, 53, and 54 to the respective VMs (OS's 31), and sends output information from the VMs to the respective input-output device sets 51, 52, 53, and 54. In this way, the input-output device sets 51, 52, 53, and 54 function respectively as direct input and output (I/O) for the respective OS's 31a, 31b, 31c, and 31d.

In each VM started by the VM startup unit 22 as described above, the authentication UI unit 32 starts operating first. Each VM has two modes, namely, an authentication UI mode and a desktop UI mode. Immediately subsequent to the startup, the authentication UI mode is selected. In the authentication UI mode, the authentication UI unit 32 remains operative, performing only a user authentication process. In the desktop UI mode, the desktop UI unit 35 remains operative, and the OS 31 performs a standard operation.

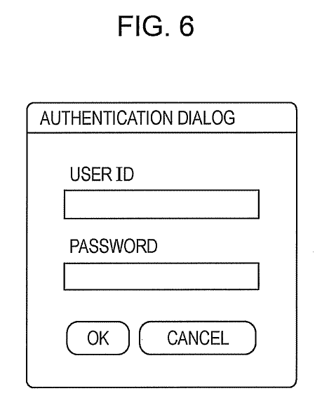

The authentication UI unit 32 (input receiving unit) causes the monitor 51a (52a, 53a, or 54a) assigned to own VM to display a display screen as illustrated in FIG. 6. The authentication UI unit 32 is thus ready receive information authenticating the user. FIG. 6 illustrates the display screen. An authentication dialog illustrated in FIG. 6 includes input boxes for the user ID (user information) and the password (authentication information), an OK button, and a cancel button. A user wishing to use the PC 10 inputs the user ID and the password using one of the input-output device sets 51, 52, 53, and 54.

The user ID and password are now input using one of the input-output device sets 51, 52, 53, and 54 and the OK button is selected. The authentication UI unit 32 (user information acquisition unit) responsive to the input-output device set 51 (52, 53 or 54) previously used acquires the user ID and the password. More specifically, the authentication UI unit 32 acquires the user ID and password via the input-output device set 51 (52, 53 or 54) corresponded to own VM. The authentication UI unit 32 (authentication requesting unit) notifies the authentication unit 25 in the VMM 21 of the acquired user ID and password and requests the authentication unit 25 to authenticate the acquired user ID and password.

On the basis of the stored content on the user information table 4c, the authentication unit 25 authenticates the user ID and password acquired from the authentication UI unit 32, and sends the authentication result to the authentication UI unit 32. More specifically, the authentication unit 25 determines whether the user ID and password acquired from the authentication UI unit 32 are stored on the user information table 4c.

Upon determining that the acquired user ID and password are stored on the user information table 4c, the authentication unit 25 (authentication result notifier) sends to the authentication UI unit 32 the authentication result that the user ID and password have been successfully authenticated. On the other hand, if it is determined that the acquired user ID and password are not stored on the user information table 4c, the authentication unit 25 (authentication result notifier) sends to the authentication UI unit 32 the authentication result that the user ID and password have failed to be authenticated.

Upon receiving the authentication result indicating the authentication failure from the authentication unit 25 in the VMM 21, the authentication UI unit 32 displays a message reading for example, “user ID error or password error.” The authentication UI unit 32 displays again the authentication dialog illustrated in FIG. 6, and is ready to receive the information for user authentication.

Upon receiving the authentication result indicating a successful authentication from the authentication unit 25 in the VMM 21, the authentication UI unit 32 notifies the user determiner 33 of the authenticated user ID. The user determiner 33 (determiner) determines whether the user ID that the authentication UI unit 32 has notified of matches the user ID of the user pre-corresponded to own VM. It is noted that the user ID of the user pre-corresponded to own VM is stored as system information for VM on the HDD 4 or the like on a per OS 31 basis.

If the user IDs match each other, the user determiner 33 instructs the mode switch 34 to change the mode from the authentication UI mode to the desktop UI mode. In such a case, the VM corresponded to the input-output device set 51 (52, 53 or 54) used by the user in the inputting of the user ID and password is the VM pre-corresponded to the user, and that VM is simply used as is.

In response to the instruction from the user determiner 33 to change the mode from the authentication UI mode to the desktop UI mode, the mode switch 34 ends the displaying of the authentication dialog displayed on the monitor 51a (52a, 53a or 54a) by the authentication UI unit 32. The mode switch 34 (operation starting unit) causes the desktop UI unit 35 to start operating. The user can thus start using the VM assigned to themselves in the desktop UI mode.

If the user IDs fail to match each other, the user determiner 33 (identification requesting unit) notifies the target VM decision unit 26 in the VMM 21 of the user ID that the authentication UI unit 32 has notified the determiner 33 of. The user determiner 33 requests the target VM decision unit 26 to identify another VM corresponded to the user ID. In this case, the VM corresponded to the input-output device set 51 (52, 53 or 54) used by the user in the inputting of the user ID and password is not the VM pre-corresponded to the user, and the other VM corresponded to the user is to be identified.

For simplicity of explanation, the VM pre-corresponded to the input-output device set 51 (52, 53 or 54) used by the user in the inputting of the user ID and password is referred to as a pre-switch VM and the VM corresponded to the user is referred to as a post-switch VM hereinafter.

The target VM decision unit 26 (identifying unit) identifies the VM (post-switch VM) corresponded to the user ID that the user determiner 33 in the pre-switch VM has notified of, based on the stored content on the VM-user mapping table 4a. More specifically, the target VM decision unit 26 reads from the VM-user mapping table 4a the VM-ID (VM-ID of the post-switch VM) stored on the VM-user mapping table 4a in response to the user ID that the user determiner 33 has notified of. The target VM decision unit 26 then instructs the device switch 23 (interchanging unit) to map the input-output device set 51 (52, 53, or 54) used by the user to the post-switch VM.

In response to the switch instruction to switch the corresponding between the VMs and the input-output device sets 51, 52, 53, and 54, the device switch 23 deprives the pre-switch VM of the input-output device set 51 (52, 53, or 54) used by the user. The device switch 23 deprives the post-switch VM at this moment of the input-output device set 52 (51, 53, or 54). The device switch 23 then corresponds the input-output device set 51 (52, 53, or 54) used by the user to the post-switch VM. The device switch 23 corresponds the input-output device set 52 (51, 53, or 54), which the device switch 23 has deprived the post-switch VM of, to the pre-switch VM.

When depriving the VM of the input-output device set 51 (52, 53, or 54), the device switch 23 deletes the input-output device ID stored on the VM-device mapping table 4d in response to the VM-ID of the VM. Also, when corresponding the VM to the input-output device set 51 (52, 53, or 54), the device switch 23 stores the input-output device ID of the input-output device set 51 (52, 53, or 54) in correspond with the VM-ID of the VM on the VM-device mapping table 4d.

The device switch 23 notifies the device sorter 24 of the stored content on the VM-device mapping table 4d when the device switch 23 has completed the switching between the input-output device set 51 (52, 53, or 54) corresponded to the pre-switch VM and the input-output device set 52 (51, 53, or 54) corresponded to the post-switch VM. The device sorter 24 can thus update the correspondence of the post-switch VMs and the input-output device sets 51, 52, 53, and 54.

After the device switch 23 corresponds between the input-output device set 51 (52, 53, or 54) used by the user and the post-switch VM, the target VM decision unit 26 in the VMM 21 instructs the device switch 23 in the post-switch VM to change the mode from the authentication UI mode to the desktop UI mode. In response to the switch instruction of the target VM decision unit 26 in the VMM 21 from the authentication UI mode to the desktop UI mode, the mode switch 34 ends the displaying of the authentication dialog displayed by the authentication UI unit 32. The mode switch 34 causes the desktop UI unit 35 to start operating. The user can thus start operating the VM assigned themselves in the desktop UI mode.

After the pre-switch VM is assigned to the input-output device set 52 (51, 53, or 54) assigned heretofore to the post-switch VM, the authentication UI unit 32 displays the authentication dialog on the corresponded monitor 52a (51a, 53a, or 54a).

Even if the user uses any of the input-output device sets 51, 52, 53, and 54, the input-output device set 51 (52, 53, or 54) used by the user is corresponded to the VM assigned to the user. This arrangement eliminates the need for the user to use a particular one of the input-output device set 51 (52, 53, or 54) when the user uses the VM. Also, this arrangement provides freedom in installation location and increases user friendliness.

If the user enters an end instruction to end the operation in the VM that started operating in the desktop UI mode, the OS 31 instructs the mode switch 34 to change the mode from the desktop UI mode to the authentication UI mode. In response to the instruction of the OS 31 to change the mode from the desktop UI mode to the authentication UI mode, the mode switch 34 causes the desktop UI unit 35 to end the operation thereof, and causes the authentication UI unit 32 to start operating. The VM thus starts operating in the authentication UI mode. The authentication dialog illustrated in FIG. 6 is displayed on the monitor 51a (52a, 53a, or 54a) corresponded to the VM.

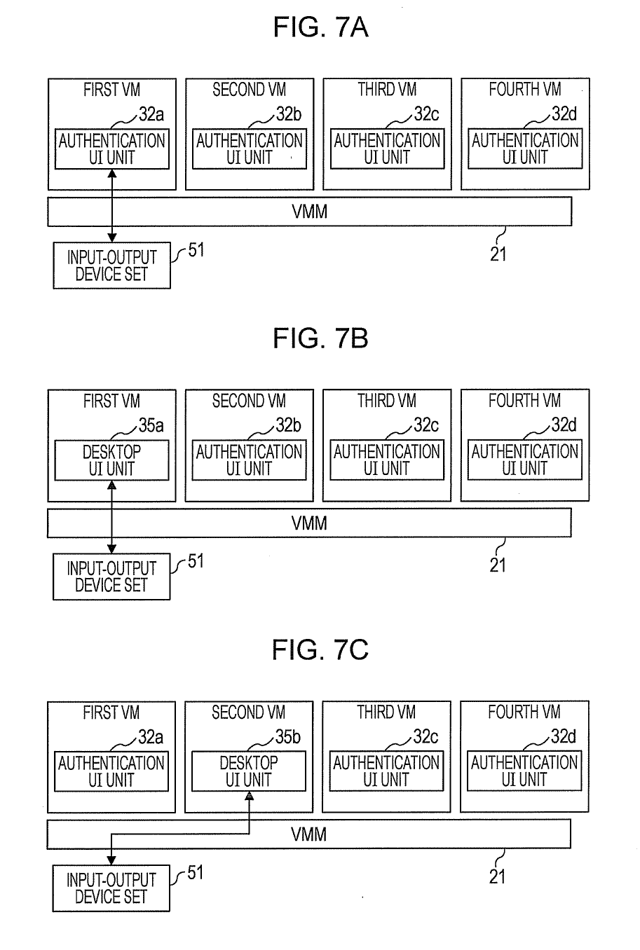

The operation of the above-described PC 10 is specifically described. FIGS. 7A-7C illustrate the operation of the PC 10 of the first embodiment. The PC 10 is powered on, starting the VMM 21. The VMM 21 then activate each VM. Referring to FIG. 7A, the authentication UI units 32a, 32b, 32c, and 32d become operative in the respective VMs activated by the VMM 21. Now it is assumed in this condition that the user inputs the user ID and password of the user using the input-output device set 51 (52, 53, or 54) corresponded to the first VM. The user ID and password are acquired by the authentication UI unit 32a of the first VM.

The user ID and password acquired by the authentication UI unit 32a of the first VM are to be authenticated by the VMM 21 (the authentication unit 25). If the user ID and password are successfully authenticated, the user determiner 33a of the first VM determines whether the user having the user ID is the user of the first VM. If the user is the user of the first VM, the mode switch 34a changes the mode of the first VM from the authentication UI mode to the desktop UI mode. Referring to FIG. 7B, the desktop UI unit 35a starts operating in the first VM.

If the user is not the user of the first VM, the VMM 21 (target VM decision unit 26) identifies a VM corresponded to the user. The corresponded VM may be the second VM now. In response to the identification of the second VM, the VMM 21 instructs the mode switch 34b of the second VM to change from the authentication UI mode to the desktop UI mode. In this way, the mode switch 34b changes the mode of the second VM from the authentication UI mode to the desktop UI mode. Referring to FIG. 7C, the desktop UI unit 35b in the second VM starts operating.

The user may provide an operation end instruction to the first VM illustrated in FIG. 7B or the second VM illustrated in FIG. 7C where the desktop UI unit 35 remains operative. The mode switch 34 causes the desktop UI unit 35 to stop operating and the authentication UI unit 32 to start operating. The authentication UI units 32a, 32b, 32c, and 32d return to be operative as illustrated in FIG. 7A.

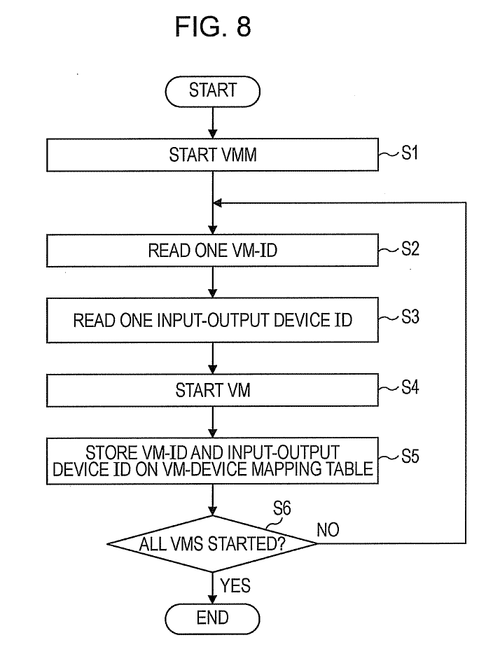

The process of the CPU 1 in the PC 10 of the first embodiment performed at power-on is described below with reference to a flowchart. FIG. 8 is the flowchart of the process of the CPU 1 performed at power-on. The CPU 1 executes the process in accordance with a control program stored on one of the ROM 2 and the HDD 4 in the PC 10.

The PC 10 is power on, and the hardware elements in the PC 10 are started up. The CPU 1 first executes the VMM program 20, thereby starting the VMM 21 (S1). The VMM 21 (CPU 1) reads one VM-ID from the VM-user mapping table 4a (S2), and one input-output device ID from the device table 4b (S3). The VMM 21 assigns (corresponds) the VM-ID read from the VM-user mapping table 4a to the input-output device set 51 (52, 53, or 54) identified by the input-output device ID read from the device table 4b, and then starts one VM (S4). The VMM 21 causes the started VM to execute the OS program 30 corresponding to the VM-ID read from the VM-user mapping table 4a.

The VMM 21 stores on the VM-device mapping table 4d the VM-ID of the started VM and the input-output device ID of the input-output device set 51 (52, 53, or 54) assigned to the VM (S5) with the VM-device corresponded to the input-output device ID. The VMM 21 determines whether the VMs corresponding to all the VM-IDs stored on the VM-user mapping table 4a have been started (S6). If it is determined that not all the VMs have been started (NO in S6), processing returns to step S2 where another VM-ID is read from the VM-user mapping table 4a (S2).

The VMM 21 cycles through steps S2-S6 until the VMs corresponding to all the VM-IDs stored on the VM-user mapping table 4a have been started. When it is determined that all the VMs have been started (YES in S6), the VMM 21 ends the process thereof. The VMM 21 has thus completed the startup of a plurality of VMs (four VMs here), thereby allowing the plurality of VMs to operate independently.

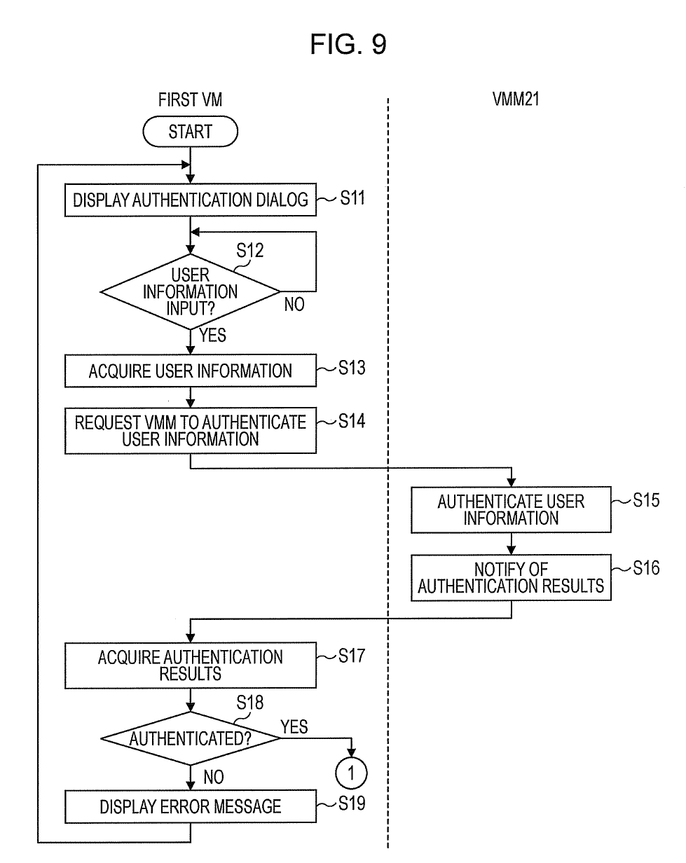

The user starts operating the PC 10 with all the VMs started as described above, using one input-output device set 51 (52, 53, or 54). The process to be performed then by the CPU 1 is described below with reference to a flowchart of FIGS. 9-11. FIGS. 9-11 illustrate a user authentication process. The process described below is performed by the VMM 21 and the VM (the OS 31) in accordance with the control program stored on one of the ROM 2 and the HDD 4 in the PC 10.

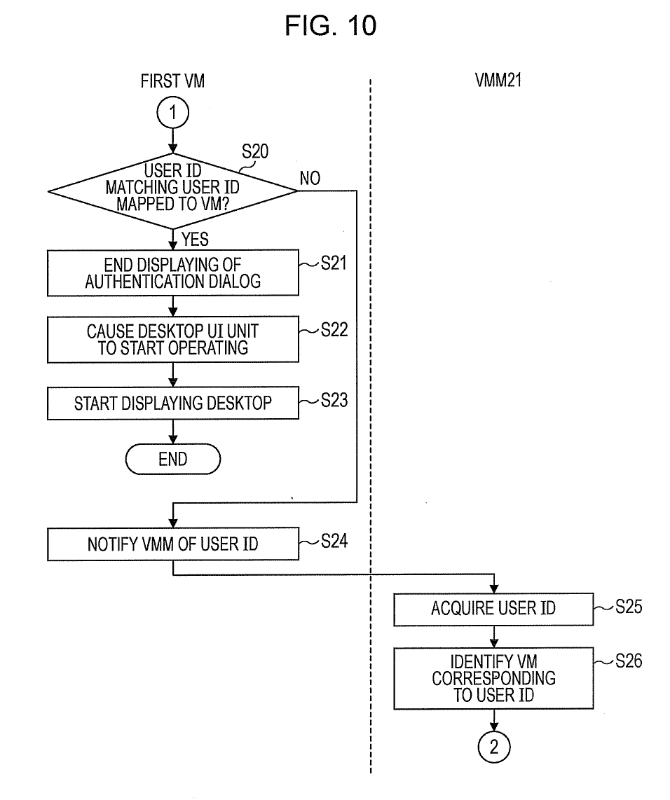

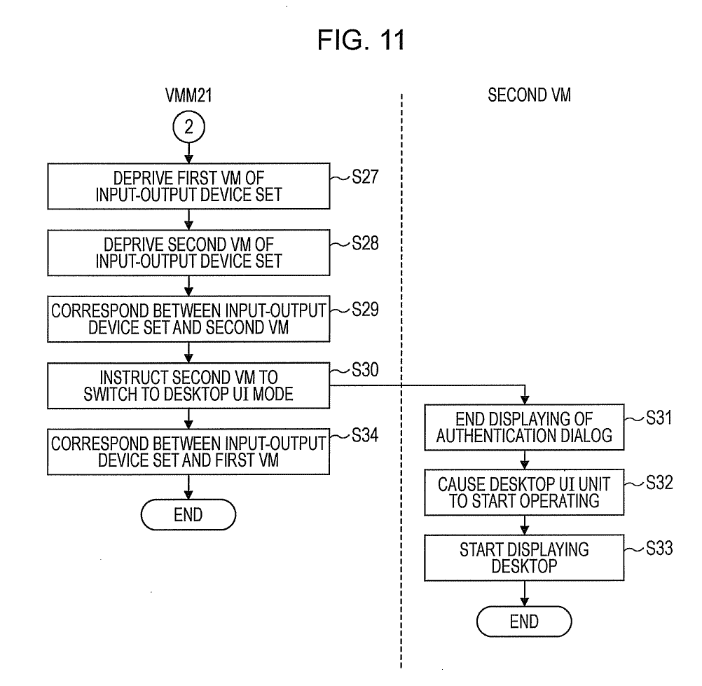

The CPU 1 (the VMM 21 and the VM) performs the process thereof in response to the user ID and password the user has input using the input-output device set 51 corresponded to the first VM. The pages of FIGS. 9-10 are delineated by a vertically extending broken line into a left-hand side portion and a right-hand side portion. Each of FIGS. 9 and 10 illustrate a process of the first VM on the left-hand side portion thereof and a process of the VMM 21 on the right-hand side portion thereof. The page of FIG. 11 is delineated by a vertically extending broken line into a left-hand side portion and a right-hand side portion. FIG. 11 illustrates a process of the VMM 21 on the left-hand side portion thereof and a process of the second VM on the right-hand side portion thereof.

The first VM (OS 31a) started by the VMM 21 displays the authentication dialog on the corresponded monitor 51a as illustrated in FIG. 6 (S11). The first VM determines whether the user information (user ID and password) has been input via the corresponded input-output device set 51 (more specifically, the keyboard 51b and the mouse 51c) (S12). If it is determined that the user information has not been input (NO in S12), the first VM waits on standby. If it is determined that the user information has been input (YES in S12), the first VM acquires the user information (S13).

The first VM notifies the VMM 21 of the acquired user information and requests the VMM 21 to authenticate the acquired user information (S14). The VMM 21 authenticates the user information that the first VM has requested the VMM 21 to authenticate, based on the stored content on the user information table 4c (S15). The VMM 21 then notifies the first VM of the authentication result (S16).

The first VM acquires the authentication result from the VMM 21 (S17), and determines whether the acquired authentication result indicates a successful authentication (S18). If the acquired authentication result indicates a failed authentication (NO in S18), the first VM causes the corresponded monitor 51a to display a message stating that the user information has not been successfully authenticated (S19). The first VM then returns to step S11, and causes the monitor 51a to display the authentication dialog illustrated in FIG. 6 (S11).

If the acquired authentication result indicates a successful authentication (YES in S18), the first VM determines whether the user ID acquired in step S13 matches the user ID of the user pre-corresponded to the first VM as own VM(S20). It is noted that the user ID of the user pre-corresponded to the first VM as own VM is managed by the OS 31a as the system information of the first VM.

If it is determined that the user IDs match each other (YES in S20), the first VM ends the displaying of the authentication dialog displayed in step S11 (S21). The first VM causes the authentication UI unit 32a to end the operation thereof and causes the desktop UI unit 35a to start operating (S22). With the desktop UI unit 35a operating, the first VM starts displaying the desktop on the corresponded monitor 51a (S23). The first VM ends the above-described user authentication process and then starts operating in the desktop UI mode.

If the user IDs fail to match each other (NO in S20), the first VM notifies the VMM 21 of the user ID acquired in step S13 (S24). In the discussion that follows, the word user refers to the user corresponded to the second VM. The VMM 21 acquires the user ID that the first VM has notified of (S25), and identifies a VM corresponded to the user (the second VM) in accordance with the stored content in the VM-user mapping table 4a (S26).

The VMM 21 deprives the first VM of the input-output device set 51 used by the user (S27), and deprives the second VM of the input-output device set 52 corresponded to the second VM (S28). The VMM 21 corresponds between the second VM and the input-output device set 51 used by the user (S29). In this way, the input-output device set 51 is assigned to the second VM.

The VMM 21 instructs the second VM to change the mode from the authentication UI mode to the desktop UI mode (S30). Instructed by the VMM 21 to change to the desktop UI mode, the second VM ends the displaying of the authentication dialog presented by the authentication UI unit 32b (S31). The second VM causes the authentication UI unit 32b to end the operation thereof and causes the desktop UI unit 35b to start operating (S32). With the desktop UI unit 35b operating, the second VM starts displaying the desktop on the corresponded monitor 51a (S33). The second VM ends the above-described user authentication process, and starts operating in the desktop UI mode.

The VMM 21 corresponds between the first VM and the input-output device set 52 which the VMM 21 has deprived from the second VM (S34), and ends the above-described user authentication process. In this way, the input-output device set 52 is assigned to the first VM and the authentication dialog is displayed on the corresponded monitor 52a in the first VM.

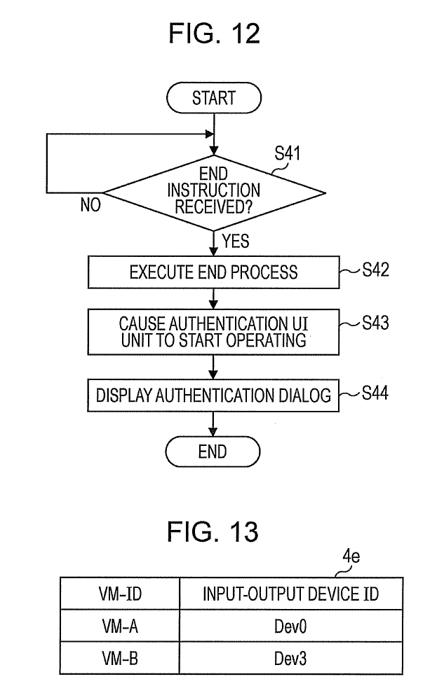

The user may now end the operation of the VM operating in the desktop UI mode of the desktop UI unit 35. The process of the CPU 1 in the ending operation of the VM is described with reference to a flowchart of FIG. 12. FIG. 12 is the flowchart illustrating the ending process of the VM. The process discussed below is executed by the CPU 1 (VM and OS 31) in accordance with the control program stored on one of the ROM 2 and the HDD 4 in the PC 10.

The VM operating in the desktop UI mode determines whether an end instruction has been received from the user (S41). If it is determined that no end instruction has been received (NO in S41), the desktop UI mode continues. If it is determined that an end instruction has been received (YES in S41), the VM causes the desktop UI unit 35 to perform the ending process (S42). After storing on the HDD 4 a variety of information to be stored, the desktop UI unit 35 ends the operation thereof. After the desktop UI unit 35 completes the end process thereof, the VM causes the authentication UI unit 32 to start operating (S43). With the authentication UI unit 32 operating, the VM causes the monitor 51a (52a, 53a, or 54a) corresponded thereto to display the authentication dialog (S44). The VM ends the operation in the desktop UI mode and then returns to a wait standby state in which the user ID and password are to be received on the authentication dialog.

In accordance with the first embodiment, the four VMs are constructed in the PC 10 so that four users can use the single PC 10. The information processing apparatus disclosed herein is not limited to such a construction. The number of VMs may be appropriately adjusted depending on the number of USB ports 5a and the number of monitor connection ports 6a arranged in the PC 10.

Even if any one of the input-output device sets 51, 52, 53, and 54 is used on the PC 10 of the first embodiment by the user, the input-output device set 51 (52, 53, or 54) used by the user is corresponded to the VM assigned to the user. When the user uses their own VM, the input-output device the user can use is not limited any particular one of the input-output device sets 51, 52, 53, and 54. Also, this arrangement provides freedom in installation location and increases user friendliness.

In the PC 10 of the first embodiment, the user information (user ID and password) input from any one of the input-output device sets 51, 52, 53, and 54 is sent to the VM (OS's 31a, 31b, 31c, and 31d) pre-corresponded thereto. The VMM 21 simply authenticates the user information acquired by each VM, and the user is thus authenticated through a simple authentication process.

More specifically, the VMM 21 receives the user information input via the input-output device sets 51, 52, 53, and 54, and performs the authentication process. In this case, it is difficult for the VMM 21 to determine which of the keyboards 51b, 52b, 53b, and 54b of the input-output device sets 51, 52, 53, and 54 is the keyboard through which the user information has been input. The first embodiment is free from such a problem. A typical VMM has no UI function, and the VMM needs to be provided with the UI function in order to display the authentication dialog of FIG. 6 on the monitors 51a, 52a, 53a, and 54a. The first embodiment is also free from such a problem.

Using the authentication UI unit 32 of the VM pre-assigned to any of the four users, the PC 10 of the first embodiment receives the user information of the user having requested the use of the VM. It is not necessary to arrange an authentication VM separate from the VM of each user. License fee for the use of the authentication VM and resources in the user of the authentication VM are thus eliminated.

In accordance with the first embodiment, each VM is started at the power-on of the PC 10, and then waits on standby until the user starts using the PC 10 in the authentication UI mode. If the user is authenticated, each VM of the first embodiment simply changes from the authentication UI mode to the desktop UI mode. The waiting time extending from the authentication of the user to the start of the usable state of the VM is shorter in the first embodiment than in an arrangement in which the VM is started only subsequent to the completion of the authentication of the user. In accordance with the first embodiment, the desktop UI unit 35 remains inoperative in each VM in the authentication UI mode. Resources used in the operation of the desktop UI unit 35 are left unused.

### Second Embodiment

A PC of a second embodiment is descried below. The PC of the second embodiment is similar in structure to the PC 10 of the first embodiment. The elements identical to those in the first embodiment are designated with the same reference numerals and the discussion thereof is omitted.

When the VMM 21 starts the four VMs in accordance with the first embodiment, the VMs identified by the VM-IDs that are read from the VM-user mapping table 4a starting from the top of the table are respectively corresponded to the input-output device sets 51, 52, 53, and 54 identified by the input-output device IDs that are read from the device table 4b starting from the top of the table.

In contrast, when the VMM 21 starts the four VMs in the PC 10 of the second embodiment, the input-output device sets 51, 52, 53, and 54 previously used by the users of the VMs are corresponded to the VMs, respectively.

The HDD 4 in the PC 10 of the second embodiment stores a history information table 4e as illustrated in FIG. 13. FIG. 13 illustrates the stored content on the history information table 4e. Referring to FIG. 13, the history information table 4e (input mapping storage unit) stores history information that corresponds between the VM-IDs of the VMs and the input-output device IDs of the input-output device sets 51, 52, 53, and 54 which used by user at past. The stored content on the history information table 4e is registered or updated by the VMM 21 each time the user of each VM uses the VM with one of the input-output device sets 51, 52, 53, and 54 corresponded to one of the VMs.

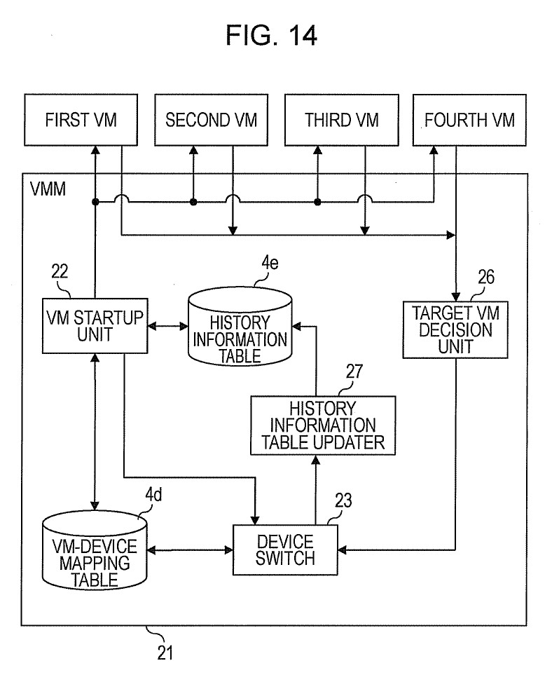

The CPU 1 in the PC 10 of the second embodiment performs the functions illustrated in FIGS. 4 and 5 by executing a variety of control programs stored on one of the ROM 2 and the HDD 4. The CPU 1 of the second embodiment has the function of a history information table updater 27 in addition to the functions illustrated in FIGS. 4 and 5. FIG. 14 is a functional block diagram of the PC 10 of the second embodiment. FIG. 14 illustrates, as the functions of the VMM 21, only the functions of VM startup unit 22, device switch 23, target VM decision unit 26 and history information table updater 27. The CPU 1 includes the functions illustrated in FIGS. 4 and 5.

The VM startup unit 22 in the VMM 21 of the second embodiment first reads a single piece of history information (a VM-ID and an input-output device ID) from the history information table 4e. The VM startup unit 22 assigns the input-output device set 51 (52, 53, or 54) identified by the input-output device ID read from the history information table 4e to the VM-ID read from the history information table 4e, and then starts the VM. The VM startup unit 22 causes each of the started VMs to execute the OS program 30 corresponding to the VM-ID read from the history information table 4e, thereby starting the OS 31. The VM startup unit 22 then stores the VM-ID of the started VM and the input-output device ID of the input-output device set 51 (52, 53, or 54) assigned to the VM onto the VM-device mapping table 4d with the VM-ID corresponded to the input-output device ID.

The VM startup unit 22 starts the VMs of all the history information stored on the history information table 4e. Two VMs having VM-A and VM-B as the VM-IDs on the history information table 4e of FIG. 13 are started.

As the VM startup unit 22 of the first embodiment, the VM startup unit 22 of the second embodiment starts the VM having no history information on the history information table 4e, based on the stored content on the VM-user mapping table 4a and the device table 4b. More specifically, the VM startup unit 22 reads the VM-IDs of unstarted VMs out of the VMs from the VM-user mapping table 4a, starting from the top of the table. Moreover, the VM startup unit 22 reads the input-output device IDs of the input-output device sets 51, 52, 53, and 54 not yet assigned to the VMs, out of the input-output device IDs stored on the device table 4b, starting from the top of the table.

The VM startup unit 22 assigns the VM-ID read from the VM-user mapping table 4a to the input-output device set 51 (52, 53, or 54) identified by the input-output device ID read from the device table 4b, and then starts the VM. The VM startup unit 22 then causes the started VM to execute the OS program 30 corresponding to the VM-ID read from the VM-user mapping table 4a, thereby starting the OS 31. The VM startup unit 22 stores the VM-ID of the VM and the input-output device ID of the input-output device set 51 (52, 53, or 54) assigned to the VM on the VM-device mapping table 4d with the VM-ID corresponded to the input-output device ID.

The VM startup unit 22 starts the VMs corresponding to all the VM-IDs stored on the VM-user mapping table 4a. After causing all the VMs to start, the VM startup unit 22 notifies the device switch 23 that all the VMs have been started. The process to be performed by the device switch 23 in response to the notification that all the VMs have been started is identical to the corresponding process previously discussed with reference to the first embodiment, and the discussion thereof is omitted here.

The target VM decision unit 26 instructs the device switch 23 of the second embodiment to assign the input-output device set 51 (52, 53, or 54) used by the user to the post-switch VM. The device switch 23 switches the correspondence of between the VMs and the input-output device sets 51, 52, 53, and 54 and then notifies the history information table updater 27 that the correspondence has been switched.

When notified that the correspondence of between the VMs and the input-output device sets 51, 52, 53, and 54 has been switched, the history information table updater 27 stores the VM-IDs of the notified VMs and the input-output device IDs of the notified input-output device sets 51, 52, 53, and 54 on the history information table 4e with the VM-IDs corresponded to the input-output device IDs respectively. More specifically, the history information table updater 27 determines whether the VM-ID of the notified VM has been stored on the history information table 4e. If it is determined whether the VM-ID of the notified VM has been stored on the history information table 4e, the history information table updater 27 updates the input-output device ID stored on the history information table 4e to be the input-output device ID that the device switch 23 has notified of in response to the VM-ID.

If it is determined whether the VM-ID of the notified VM has not been stored on the history information table 4e, the history information table updater 27 stores the VM-ID and input-output device ID that the device switch 23 has notified of onto the history information table 4e with the VM-ID corresponded to the input-output device ID. The arrangement allows the user to learn which input-output device set is used when the user uses a VM.

The functions of the CPU 1 of the second embodiment remain unchanged from the functions of the CPU 1 of the first embodiment previously discussed except the processes of the VM startup unit 22 and the history information table updater 27.

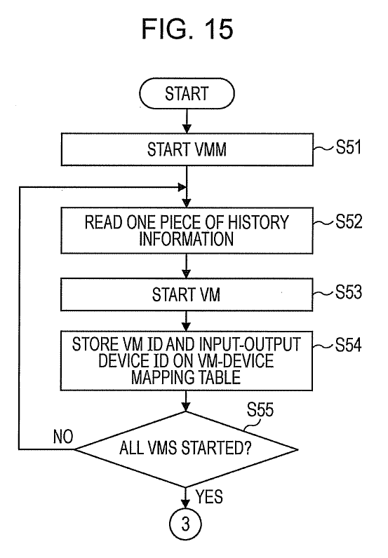

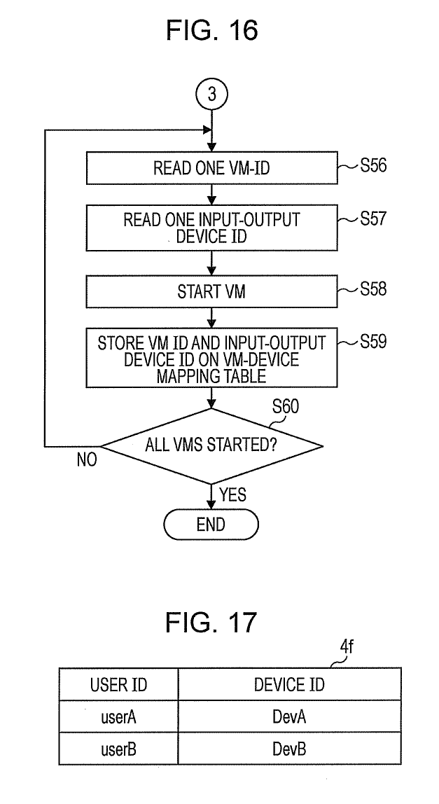

The process of the CPU 1 performed at the power-on of the PC 10 of the second embodiment is described below with reference to a flowchart of FIGS. 15 and 16. FIGS. 15 and 16 is the flowchart of the process of the CPU 1 performed at the power-on. The CPU 1 performs the process thereof in accordance with the control program stored on one of the ROM 2 and the HDD 4 in the PC 10.

The PC 10 is now powered on, completing the startup of each hardware element therewithin. The CPU 1 first executes the VMM program 20, thereby starting the VMM 21 (S51). The VMM 21 (the CPU 1) reads one piece of history information from the history information table 4e (S52). The VMM 21 assigns the VM-ID contained in the read history information to the input-output device set 51 (52, 53, or 54) identified by the input-output device ID contained in the history information, and starts one VM (S53). The VMM 21 then causes the started VM to execute the OS program 30 corresponding to the VM-ID contained in the read history information.

The VMM 21 then stores the VM-ID of the started VM and the input-output device ID of the input-output device set 51 (52, 53, or 54) assigned to the VM onto the VM-device mapping table 4d with the VM-ID corresponded to the input-output device ID (S54). The VMM 21 determines whether all the VMs corresponding to the history information stored on the history information table 4e have been started (S55). If it is determined that not all the VMs have been started (NO in S55), the VMM 21 returns to step S52 and then reads another piece of history information from the history information table 4e (S52).

The VMM 21 cycle through steps S52-S55 until all the VMs of the history information stored on the history information table 4e are started. If it is determined that all the VMs have been started (YES in S55), the VMM 21 reads the VM-ID of any unstarted VM out of the VMs stored on the VM-user mapping table 4a (S56). Furthermore, the VMM 21 reads the input-output device ID of any one of the input-output device sets 51, 52, 53, and 54 not assigned to any VM (S57).

The VMM 21 executes the OS program 30 corresponding to the VM-ID read from the VM-user mapping table 4a. The VMM 21 then assigns to the started OS 31 the input-output device set 51 (52, 53, or 54) identified by the input-output device ID read from the device table 4b, and starts the VM (S58).

The VMM 21 stores the VM-ID of the started VM and the input-output device ID of the input-output device set 51 (52, 53, or 54) assigned to the VM onto the VM-device mapping table 4d with the VM-ID corresponded to the input-output device ID (S59). The VMM 21 determines whether the VMs corresponding to all the VM-IDs stored on the VM-user mapping table 4a have been started (S60). If it is determined that not all the VMs have been started (NO in S60), the VMM 21 returns to step S56. The VMM 21 then reads the VM-ID of any one unstarted VM from among the VM-IDs stored on the VM-user mapping table 4a (S56).

The VMM 21 cycles through steps S56-S60 until the VMs of all the VM-IDs stored on the VM-user mapping table 4a are started. If it is determined that all the VMs have been started (YES in S60), the VMM 21 ends the process. In this way, the VMM 21 ends the starting process of a plurality of VMs (four VMs here), thereby allowing the plurality of VMs to operate independently.

The PC 10 of the second embodiment manages on the history information table 4e the correspondence of between the VM assigned to the user and the input-output device set 51 (52, 53, or 54) used when the user used previously the VM. At the start-up of each VM, the VM startup unit 22 corresponds to the VM the input-output device set 51 (52, 53, or 54) used by the user of the VM. In this way, the number of occurrences of switching operations between each of the VMs and each of the input-output device sets 51, 52, 53, and 54 is reduced. This is because it is more likely that the same user uses the same one of the input-output device sets 51, 52, 53, and 54.

The process of the CPU 1 of the second embodiment performed when the user starts operating the PC 10 (VM) using the input-output device set 51 (52, 53, or 54) remains unchanged from the process of the first embodiment discussed with reference to FIGS. 9-11 and the discussion thereof omitted here. Subsequent to step S34, the VMM 21 (history information table updater 27) of the second embodiment performs a process step of storing, on the history information table 4e, the VM-ID corresponded to the second VM in step S29 and the input-output device ID of the input-output device set 51 and a process step of storing, on the history information table 4e, the VM-ID corresponded to the first VM in step S34 and the input-output device ID of the input-output device set 52.

An ending process of the VM in the PC 10 of the second embodiment with the desktop UI unit 35 operating in the desktop UI mode is identical to the ending process of the first embodiment discussed with reference to FIG. 12, and the discussion thereof is omitted here.

The history information stored on the history information table 4e in the PC 10 of the second embodiment is only the input-output device IDs of the input-output device sets 51, 52, 53, and 54 that were used by the users of the VMs in an immediately preceding operation. Alternatively, history information related to the use of each of the input-output device sets 51, 52, 53, and 54 may be stored and the input-output device set 51 (52, 53, or 54) highly likely to be used by the user may be identified. The identified input-output device set 51 (52, 53, or 54) is corresponded to the VM of each user at the start-up, and the number of occurrences of switch operations between of each of the VMs and each of the input-output device sets 51, 52, 53, and 54 is reduced.

### Third Embodiment

A PC of a third embodiment is described below. The PC of the third embodiment is similar in structure to the PC of the first embodiment. Elements identical to those in the first embodiment are designated with the same reference numerals and the discussion thereof is omitted here.

In accordance with the first embodiment, the input-output device sets 51, 52, 53, and 54 are respectively corresponded to the four VMs. In contrast, in the PC 10 of the third embodiment, not only the input-output device sets 51, 52, 53, and 54 but also another input-output device is corresponded to a VM depending on the VM so that the other input-output device is used. The input-output devices other than the input-output device sets 51, 52, 53, and 54 may include a flexible disk drive (FDD), an optical-disc drive for a compact disc (CD) or a digital versatile disc (DVD) or the like, a printer, a loudspeaker, etc.

The HDD 4 in the PC 10 of the third embodiment stores a device mapping table 4f as illustrated in FIG. 17. FIG. 17 illustrates a stored content on the device mapping table 4f. Referring to FIG. 17, the device mapping table 4f (input-output device mapping storage unit) stores a user ID of a user using the PC 10, and a device ID identifying an input-output device operating on the VM of the user with the user ID corresponded to the device ID. The stored content on the device mapping table 4f is registered by each user at the initial setting process of the PC 10 and updated by the corresponding OS's 31a, 31b, 31c, and 31d when the user updates a registration on own VM during the use of the VM.

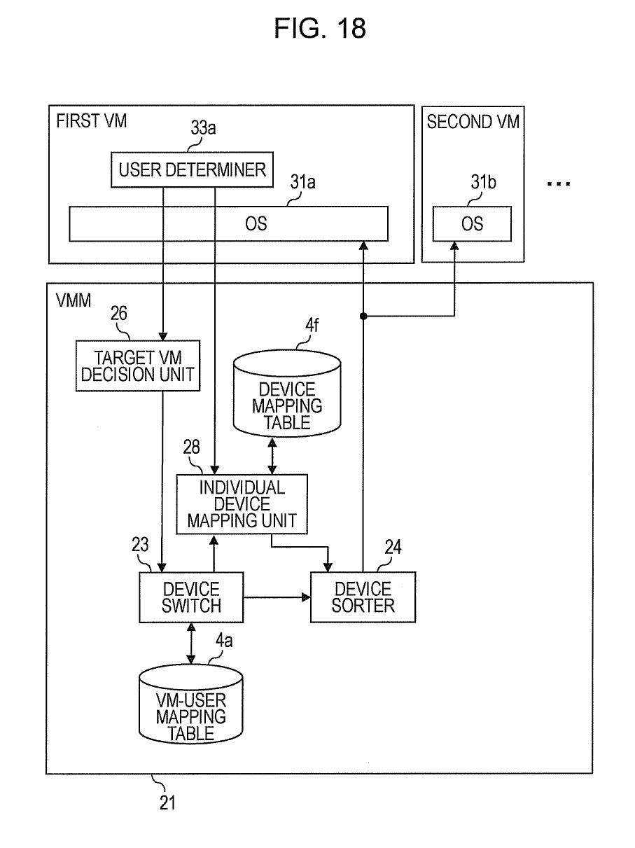

The CPU 1 in the PC 10 of the third embodiment performs the functions illustrated in FIGS. 4 and 5 by executing a variety of control programs stored on one of the ROM 2 and the HDD 4. The CPU 1 of the third embodiment has also a function of an individual device mapping unit 28 in addition to the functions illustrated in FIGS. 4 and 5. FIG. 18 is a functional block diagram the PC 10 of the third embodiment. FIG. 18 illustrates as the functions of the VMM 21 only functions of device switch 23, device sorter 24, target VM decision unit 26, and individual device mapping unit 28. The CPU 1 also has the functions illustrated in FIGS. 4 and 5.

The user determiner 33 in each VM of the third embodiment determines whether the user ID that the authentication UI unit 32 has notified of matches the user ID of the user pre-corresponded to own VM. If it is determined that the user IDs match each other, the user determiner 33 instructs the mode switch 34 to change the mode from the authentication UI mode to the desktop UI mode, and then notifies the individual device mapping unit 28 in the VMM 21 of the user ID.

Notified of the user ID by the user determiner 33 of any VM, the individual device mapping unit 28 (mapping control unit) reads the device ID stored on the device mapping table 4f and corresponded to the notified user ID. The individual device mapping unit 28 instructs the device sorter 24 to correspond between the input-output device identified by the read device ID and the VM assigned to the user identified by the notified user ID.

More specifically, the individual device mapping unit 28 reads from the VM-user mapping table 4a the VM-ID corresponding to the notified user ID. The individual device mapping unit 28 then instructs the device sorter 24 to map the input-output device identified by the device ID read from the device mapping table 4f to the VM identified by the VM-ID read from the VM-user mapping table 4a.

In response to the instruction from the individual device mapping unit 28, the device sorter 24 sorts the input-output devices to the OS's 31a, 31b, 31c, and 31d. The input-output devices corresponded to the OS's 31a, 31b, 31c, and 31d through the above-described process are placed in the vicinities of the respective input-output device sets 51, 52, 53, and 54 used by the users. In this way, the user can use the other input-output devices in addition to the input-output device set 51 (52, 53, or 54).

When requested by the target VM decision unit 26 to assign the input-output device set 51 (52, 53, or 54) used by the user to the post-switch VM, the device switch 23 in the VMM 21 of the third embodiment switches the corresponding between the VMs and the input-output device sets 51, 52, 53, and 54. After switching the corresponding between the VMs and the input-output device sets 51, 52, 53, and 54, the device switch 23 notifies the device sorter 24 of the stored content on the VM-device mapping table 4d. The device switch 23 then notifies the individual device mapping unit 28 in the VMM 21 of the user ID of the user assigned to the post-switch VM. More specifically, the device switch 23 identifies the user ID corresponding to the post-switch VM on the VM-user mapping table 4a and then notifies the individual device mapping unit 28 of the user ID.

When notified by the device switch 23 of the user ID, the individual device mapping unit 28 (mapping control unit) performs the same process as the process performed when notified by the user determiner 33 of the VM of the user ID as described above. More specifically, the individual device mapping unit 28 reads the device ID stored on the device mapping table 4f and corresponded to the notified user ID. The individual device mapping unit 28 then instructs the device sorter 24 to correspond the input-output device identified by the read device ID to the VM assigned to the user identified by the notified user ID.

The VM pre-corresponded to the input-output device set 51 (52, 53, or 54) used by the user may not be the VM assigned to the user. Even in such a case, the user can use the VM via not only the input-output device set 51 (52, 53, or 54) but also the input-output device other than the input-output device set 51 (52, 53, or 54).

The processes of the CPU 1 of the third embodiment are identical to those of the first embodiment except the process of the device switch 23, the device sorter 24 and the individual device mapping unit 28, and the discussion thereof is omitted here.

The VM is thus corresponded to the input-output device other than the input-output device sets 51, 52, 53, and 54 by the individual device mapping unit 28 in the VMM 21 of the third embodiment. When the operation of the VM is ended in the desktop UI mode, the VMM 21 deprives the VM of the corresponded input-output device. More specifically, if the operation of the VM in the desktop UI mode is ended, the VMM 21 identifies the input-output device corresponded to the VM on the device mapping table 4f. The VMM 21 thus deprives the VM of the identified input-output device.

If the mode switch 34 has changed the mode from the desktop UI mode to the authentication UI mode, the VMM 21 is notified of the mode switching. In this way, the VMM 21 recognizes the operation of the VM in the desktop UI mode has been ended.

The process of the CPU 1 in the PC 10 of the third embodiment is described below with reference to a flowchart. The process performed by CPU 1 when the PC 10 of the third embodiment is powered on remains unchanged from the process of the first embodiment discussed with reference to FIG. 8, and the discussion thereof is omitted here.

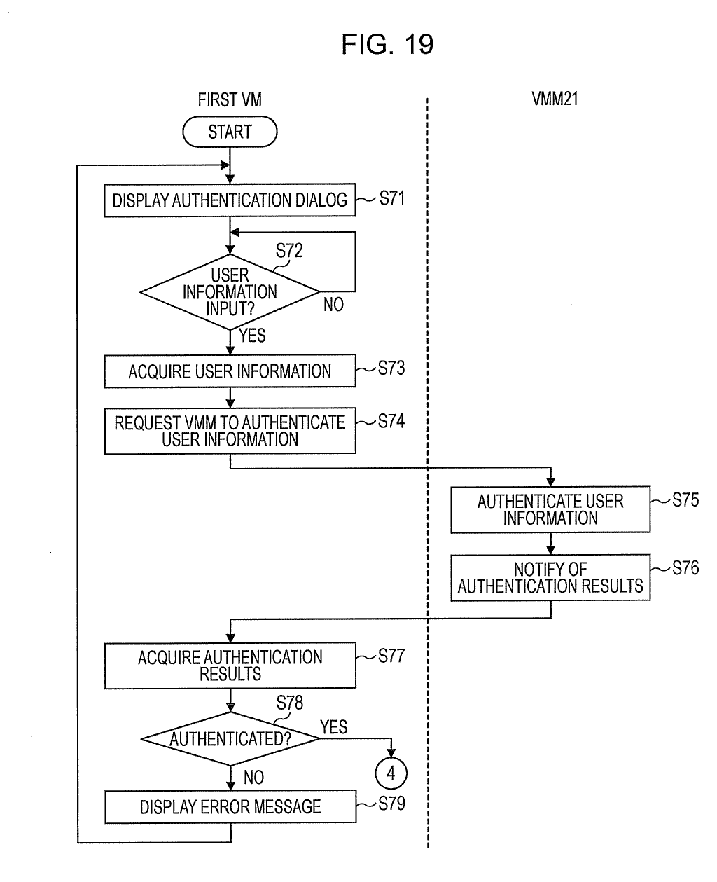

The user starts using the PC 10 (VM) of the third embodiment using the input-output device set 51 (52, 53, or 54) with all the VMs started. The process of the CPU 1 at the power-on is described with reference to the flowchart illustrated in FIGS. 19-21. FIGS. 19-21 are the flowchart of a user authentication process. The process of the flowchart is executed by the VMM 21 and the VM (OS 31) in accordance with the control program stored on one of the ROM 2 and the HDD 4 in the PC 10.

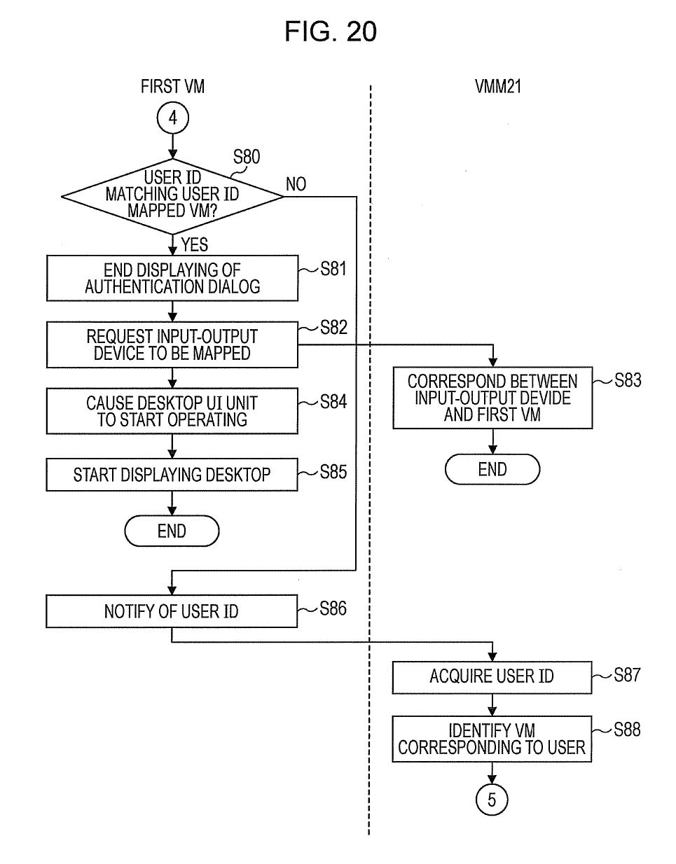

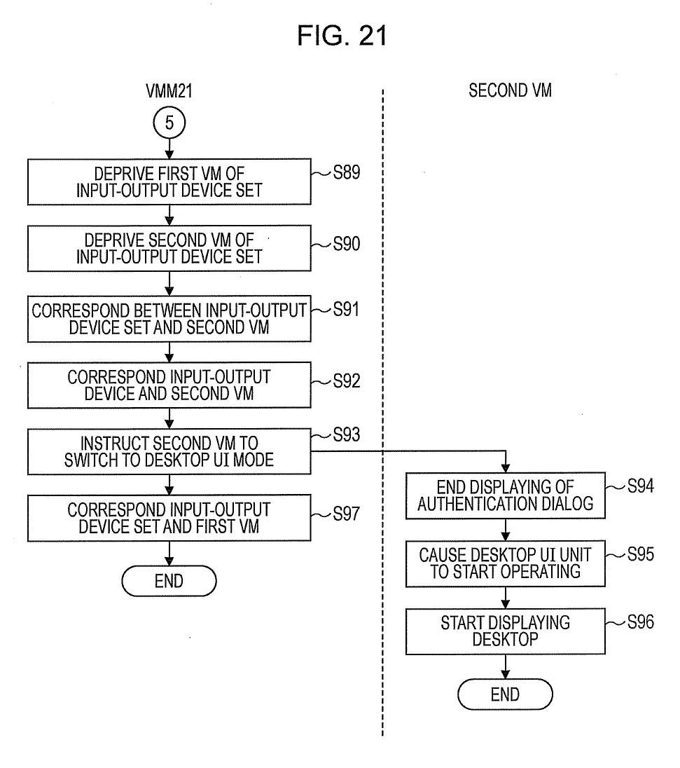

The process of the CPU 1 (the VMM 21 and the VM) described below is performed when the user inputs the user ID and password via the input-output device set 51 corresponded to the first VM. The pages of FIGS. 19 through 20 are delineated by a vertically extending broken line into a left-hand side portion and a right-hand side portion. Each of FIGS. 19 and 20 illustrate a process of the first VM on the left-hand side portion thereof and a process of the VMM 21 on the right-hand side portion thereof. The page of FIG. 21 is delineated by a vertically extending broken line into a left-hand side portion and a right-hand side portion. FIG. 21 illustrates a process of the VMM 21 on the left-hand side portion thereof and a process of the second VM on the right-hand side portion thereof. Steps S71-S80 illustrated in FIGS. 19 and 20 are respectively identical to steps S11-S20 illustrated in FIGS. 9 and 10, and the discussion thereof is omitted here.

If it is determined that the user ID acquired in step S73 matches the user ID of the user pre-corresponded to the first VM (YES in S80), the first VM ends the displaying of the authentication dialog displayed in step S71 (S81). The first VM notifies the VMM 21 of the user ID and requests the VMM 21 to correspond the first VM to an input-output device other than the input-output device set 51 (S82).

When the correspondence of between the first VM and the input-output device is requested, the VMM 21 identifies the input-output device to be corresponded to the first VM and then corresponds between the identified input-output device and the first VM (S83). The first VM causes the authentication UI unit 32a to end the operation thereof and then causes the desktop UI unit 35a to start operating (S84). With the desktop UI unit 35a operating, the first VM starts displaying the desktop on the corresponded monitor 51a (S85). The first VM ends the above-described authentication process, and starts the operation in the desktop UI mode.

If it is determined that the user ID acquired in step S73 fails to match the user ID of the user pre-corresponded to the first VM (NO in S80), the first VM notifies the VMM 21 of the user ID acquired in step S73 (S86). In the discussion that follows, this user is the user assigned to the second VM hereinafter. The VMM 21 acquires the user ID the first VM has notified of (S87), and identifies the VM corresponding to the user (the second VM) based on the stored content on the VM-user mapping table 4a (S88).

The VMM 21 deprives the first VM of the input-output device set 51 used by the user (S89), and deprives the second VM of the input-output device set 52 assigned to the second VM (S90). The VMM 21 corresponds between the input-output device set 51 used by the user and the second VM (S91). The input-output device set 51 is thus assigned to the second VM.

The VMM 21 identifies an input-output device to be corresponded to the second VM and then corresponds between the identified input-output device and the second VM (S92). The VMM 21 instructs the second VM to change the mode from the authentication UI mode to the desktop UI mode (S93). When instructed by the VMM 21 to change the mode from the authentication UI mode to the desktop UI mode, the second VM causes the authentication UI unit 32b to end the displaying of the authentication dialog (S94).

The second VM causes the authentication UI unit 32 to end the operation thereof and then causes the desktop UI unit 35b to start operating (S95). With the desktop UI unit 35b operating, the second VM starts displaying the desktop on the corresponded monitor 51a (S96). The second VM then ends the above-described user authentication process, and then starts operating in the desktop UI mode.

The VMM 21 corresponds between the input-output device set 52 that the VMM 21 has deprived and the second VM (S97), and then ends the above-described user authentication process. In this way, the input-output device set 52 is assigned to the first VM, and the first VM displays the authentication dialog on the corresponded monitor 52a.

An ending process of the PC 10 of the third embodiment performed with the desktop UI unit 35 operating in the desktop UI mode in response to an operation end instruction from the user is identical to the ending process of the first embodiment discussed with reference to FIG. 12, and the discussion thereof is omitted here.

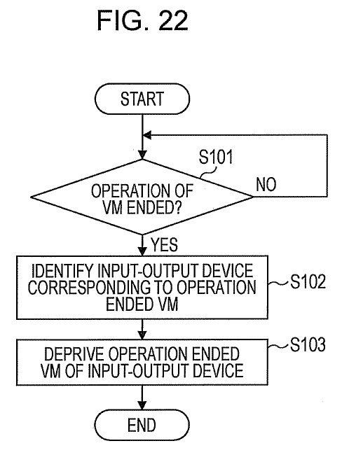

The process performed by the VMM 21 in the PC 10 of the third embodiment when the VM ends the operation thereof with the desktop UI unit 35 in the desktop UI mode is described with reference to a flowchart in FIG. 22. FIG. 22 is the flowchart of the process performed by the VMM 21 when the VM ends the operation thereof in the desktop UI mode. The process of the VMM 21 is executed by the CPU 1 (VMM 21) in accordance with the control program stored on one of the ROM 2 and the HDD 4 in the PC 10.

The VMM 21 determines whether any of the VMs has ended the operation thereof with the desktop UI unit 35 operating in the desktop UI mode (S101). If it is determined that no VM has ended the operation thereof (NO in S101), the VMM 21 continues the operation in the desktop UI mode. If it is determined that any one of the VMs has ended the operation thereof in the desktop UI mode (YES in S101), the VMM 21 identifies the input-output device corresponded to the operation ended VM in accordance with the stored content in the device mapping table 4f (S102).

The VMM 21 deprives the operation ended VM of the identified input-output device (S103), and ends the process thereof. With this arrangement, each user is thus allowed to use the VM, and after the end of the operation in the desktop UI mode of the VM, the VMM 21 reliably deprives the VM of the input-output device corresponded to the VM. This arrangement prevents any user who is not authorized to use the VM from using each input-output device.

The PC 10 of the third embodiment assigns the input-output device sets 51, 52, 53, and 54 to the VMs respectively but also allows each user to use the other input-output devices. The user can enjoy user friendliness in the use of the VMs.

In the PC 10 of the third embodiment, the input-output device is corresponded to the VM in accordance with the device mapping table 4f that stores the user ID and the device ID in a corresponded state thereof as illustrated in FIG. 17. Furthermore, the device mapping table 4f may store the VM-ID of the VM assigned to the user and the device ID with the VM-ID corresponded to the device ID.

The PC 10 of the third embodiment has been discussed as a modification to the PC 10 of the first embodiment. The structure of the PC 10 of the third embodiment is also applicable to the PC 10 of the second embodiment.

### Fourth Embodiment

A PC of a fourth embodiment is described below. The PC of the fourth embodiment is similar in structure to the PC 10 of the first embodiment. Elements identical to those in the PC 10 of the first embodiment are designated with the same reference numerals and the discussion thereof is omitted here.

The VM of the user who has input the user ID and password using one of the input-output device sets 51, 52, 53, and 54 may not be the VM corresponded to the input-output device set 51 (52, 53, or 54) used. In such a case, the PC 10 switches the correspondence of between each of the VMs and each of the input-output device sets 51, 52, 53, and 54 in accordance with the first embodiment.

The PC 10 of the fourth embodiment operates as described below. The PC 10 of the fourth embodiment switches the correspondence of between each of the VMs and each of the input-output device sets 51, 52, 53, and 54. The input-output device set 51 (52, 53, or 54) corresponded to the VM of the user is used by another user. In such a case, the PC 10 of the fourth embodiment stores information being input by the other user, and after switching the correspondence between each of the VMs and each of the input-output device sets 51, 52, 53, and 54, the PC 10 sends the stored information to the post-switch input-output device set 51 (52, 53, or 54).

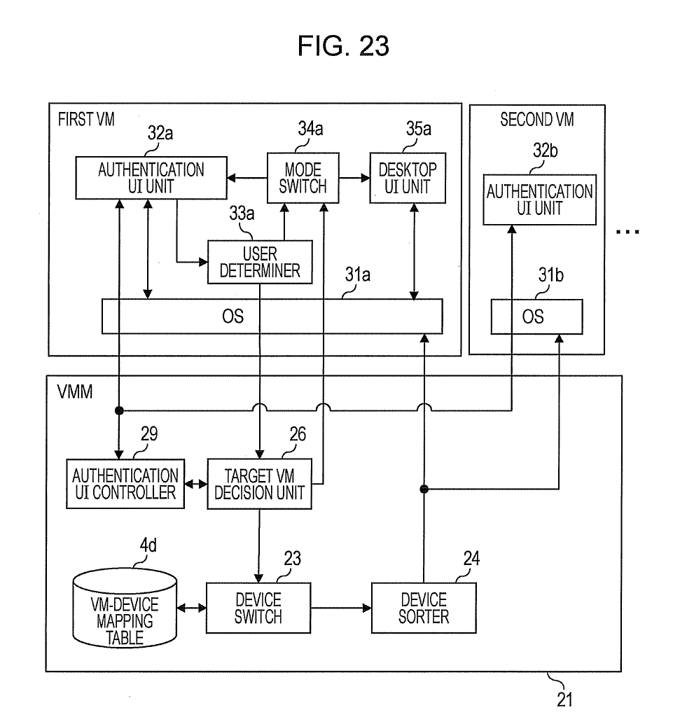

The CPU 1 in the PC 10 of the fourth embodiment executes the variety of programs stored on the ROM 2 or the HDD 4, thereby performing the functions illustrated in FIGS. 4 and 5. The CPU 1 of the fourth embodiment has a function of an authentication UI controller 29 in addition to the functions illustrated in FIGS. 4 and 5. FIG. 23 is a functional block diagram of the PC 10 of the fourth embodiment. FIG. 23 illustrates, as the functions of the VMM 21, only functions of device switch 23, device sorter 24, target VM decision unit 26, and authentication UI controller 29. The CPU 1 also has the functions illustrated in FIGS. 4 and 5.

When notified by the user determiner 33 in the VM (pre-switch VM) of the user ID, the target VM decision unit 26 in the VMM 21 of the fourth embodiment identifies a VM corresponded to the notified user ID (post-switch VM) in accordance with the stored content in the VM-user mapping table 4a. The target VM decision unit 26 instructs the device switch 23 to assign the input-output device set 51 (52, 53, or 54) used by the user to the post-switch VM. The target VM decision unit 26 then notifies the authentication UI controller 29 of the pre-switch VM and the post-switch VM.

When notified by the target VM decision unit 26 of the pre-switch VM and the post-switch VM, the authentication UI controller 29 causes the authentication UI unit 32 to suspend temporarily the reception of the user ID (the user ID and password). The authentication UI controller 29 (input information storage unit) stores the user information the authentication UI unit 32 has acquired heretofore. The authentication UI controller 29 sends the stored user information to the pre-switch VM after the device switch 23 switches the correspondence of between the VMs and the input-output device sets 51, 52, 53, and 54 in response to an instruction from the target VM decision unit 26.

The authentication UI unit 32 (notifier) of the pre-switch VM displays the user information sent from the authentication UI controller 29 on the authentication dialog displayed on the corresponded monitor 51a (52a, 53a, or 54a).

A plurality of users may input user information via the input-output device sets 51, 52, 53, and 54 at the same timing, and the correspondence of between the VMs and the input-output device sets 51, 52, 53, and 54 may be switched. In such a case, the above-described arrangement prevents information being input from being deleted in response to the switching of the correspondence. Although the input process of the user information is temporarily suspended, already input information is displayed on the authentication dialog after the suspension, and duplication of the inputting of the user information is thus avoided.

The timing at which the authentication UI controller 29 sends the stored user information to the pre-switch VM may be before or after the device switch 23 switches the correspondence of between the VMs and the input-output device sets 51, 52, 53, and 54.

The functions of the CPU 1 of the fourth embodiment are identical to the functions described with reference to the first embodiment except the above-described process of the authentication UI controller 29. The discussion thereof is thus omitted here.

The process of the CPU 1 in the PC 10 of the fourth embodiment is described below with a flowchart. The process of the CPU 1 performed at the power-on of the PC 10 of the fourth embodiment is identical to the process of the first embodiment described with reference to FIG. 8, and the discussion thereof is omitted here.

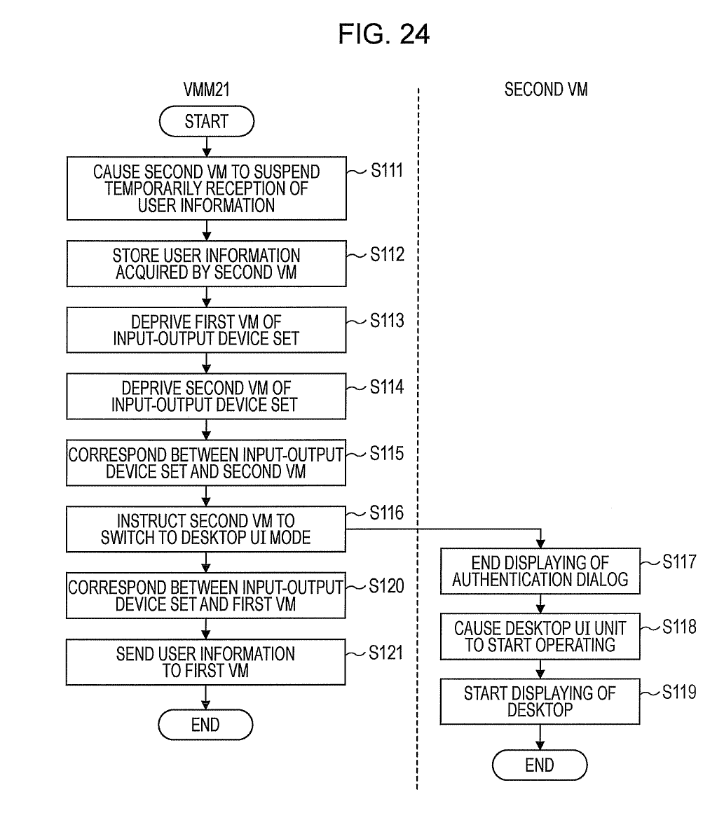

The user may start operating the PC 10 (VM) of the fourth embodiment using the input-output device set 51 (52, 53, or 54) with all the VMs operative. The process of the CPU 1 is described with the flowchart illustrated in FIG. 24. FIG. 24 is the flowchart of a user authentication process. The process of the CPU 1 is executed by the VMM 21 and the VM (OS 31) in accordance with the control program stored on one of the ROM 2 and the HDD 4 in the PC 10. The page of FIG. 24 is delineated by a vertically extending broken line into a left-hand side portion and a right-hand side portion. FIG. 24 illustrates a process of the VMM 21 on the left-hand side portion thereof and a process of the second VM on the right-hand side portion thereof.

The user authentication process of the fourth embodiment starts with the same process steps in steps S11-S26 illustrated in FIGS. 9 and 10. The same process steps are neither illustrated in FIG. 24 nor discussed here. The process of FIG. 24 is a continuation to step S26 of FIG. 10.

In step S26 of FIG. 10, the VMM 21 identifies the VM (second VM) corresponded to the user ID the first VM has notified of in accordance with the stored content in the VM-user mapping table 4a (S26). The VMM 21 causes the identified second VM to suspend temporarily the reception of the user information (the user ID and password) (S111), and stores the user information the second VM has acquired heretofore (S112).

The VMM 21 deprives the first VM of the input-output device set 51 used by the user (S113), and deprives the second VM of the input-output device set 52 assigned to the second VM (S114). The VMM 21 corresponds between the input-output device set 51 used by the user and the second VM (S115). The input-output device set 51 is thus assigned to the second VM.

The VMM 21 instructs the second VM to change the mode from the authentication UI mode to the desktop UI mode (S116). When instructed by the VMM 21 to change to the desktop UI mode, the second VM ends the displaying of the authentication dialog presented by the authentication UI unit 32b (S117).

The second VM causes the authentication UI unit 32 to end the operation thereof and causes the desktop UI unit 35b to start operating (S118). With the desktop UI unit 35b operating, the second VM starts displaying the desktop on the corresponded monitor 51a (S119). The second VM ends the above-described user authentication process, and starts operating in the desktop UI mode.

The VMM 21 then corresponds between the input-output device set 52 which the VMM 21 has deprived and the first VM (S120). In this way, the input-output device set 52 is assigned to the first VM, and the first VM displays the authentication dialog on the corresponded monitor 52a. The VMM 21 sends the user information stored in step S112 to the first VM (S121), and ends the above-described user authentication process.

The first VM displays the authentication dialog bearing the user information sent from the VMM 21 on the corresponded monitor 52a. The input process of the user information performed by the user using the input-output device set 52 including the monitor 52a is temporarily suspended. When the operation resumes, the user simply enters remaining information on the authentication dialog bearing the user information already input by the user. User friendliness is thus enhanced.

The VM operating in the desktop UI mode of the desktop UI unit 35 may receive an instruction to end the operation from the user on the PC 10 of the fourth embodiment. The process performed in this case by the VM is identical to the process of the first embodiment discussed with reference to FIG. 12, and the discussion thereof is omitted here.

The PC 10 of the fourth embodiment has been discussed as a modification to the PC 10 of the first embodiment. The structure of the PC 10 of the fourth embodiment is applicable to the PCs 10 of the second and third embodiments.

### Fifth Embodiment

A PC of a fifth embodiment is described below. The PC of the fifth embodiment is similar in structure to the PC 10 of the first embodiment. Elements identical to those in the PC 10 of the first embodiment are designated with the same reference numerals and the discussion thereof is omitted here.

In accordance with the previously described first embodiment, the VMM 21 authenticates the user information when the authentication UI unit 32 acquires the user information (the user ID and password) from the pre-corresponded one of the input-output device sets 51, 52, 53, and 54. In contrast, one of the VMs authenticates the user information acquired by the authentication UI unit 32 in each VM in the PC 10 of the fifth embodiment.

The CPU 1 in the PC 10 of the fifth embodiment executes the variety of programs stored on the ROM 2 or the HDD 4, thereby performing the functions illustrated in FIGS. 4 and 5. Each VM includes an authenticating unit 36 (36a, 36b, 36c, and 36d) in place of the user determiner 33. The VMM 21 includes no authentication unit 25.

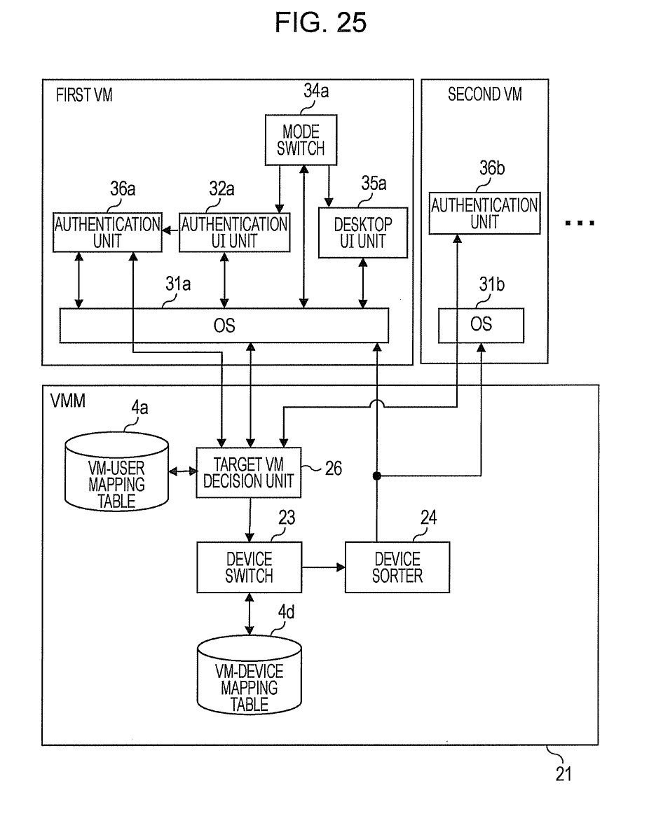

FIG. 25 is a functional block diagram of the PC 10 of the fifth embodiment. FIG. 25 illustrates, as the functions of the VMM 21, only functions of device switch 23, device sorter 24, and target VM decision unit 26. The CPU 1 also has the functions illustrated in FIGS. 4 and 5.

Upon receiving the user ID and password on the display screen illustrated in FIG. 6, the authentication UI unit 32 in each VM of the fifth embodiment notifies the authenticating unit 36 of the acquired user ID and password. The authenticating unit 36 authenticates the user ID and password that the authentication UI unit 32 has notified of, and then notifies the OS 31 of the authentication result. More specifically, the authenticating unit 36 determines whether the user ID and password acquired from the authentication UI unit 32 match the pre-stored user ID and password. It is noted that the user ID and password of the user corresponded to each VM are pre-stored as the system information of the VM on the HDD 4 or the like on a per OS 31 basis.

If it is determined that the user ID and password acquired from the authentication UI unit 32 match the pre-stored user ID and password, the authenticating unit 36 notifies the OS 31 of the authentication result that the user ID and password have been successfully authenticated. If it is determined that the user ID and password acquired from the authentication UI unit 32 fail to match the pre-stored user ID and password, the authenticating unit 36 notifies the OS 31 the authentication result that the authentication of the user ID and password has failed.

When notified by the authenticating unit 36 of the result of the successful authentication, the OS 31 instructs the mode switch 34 to change the mode from the authentication UI mode to the desktop UI mode. In response to the instruction from the OS 31 to change the mode from the authentication UI mode to the desktop UI mode, the mode switch 34 ends the displaying of the authentication dialog displayed on the corresponded monitor 51a (52a, 53a, or 54a) by the authentication UI unit 32. The mode switch 34 causes the desktop UI unit 35 to start operating. The user can thus start using the VM assigned to them in the desktop UI mode.

When notified by the authenticating unit 36 of the result of the failed authentication, the OS 31 (authentication requesting unit) notifies the target VM decision unit 26 in the VMM 21 of the user ID and password having failed to be authenticated, and requests the VMM 21 to authenticate the user ID and password.

The target VM decision unit 26 (authentication executer identifying unit) in the VMM 21 is thus requested by the VM (first VM) to authenticate the user ID and password. In accordance with the stored content on the VM-user mapping table 4a, the target VM decision unit 26 identifies the VM (second VM) corresponding to the user ID acquired from the OS 31a in the first VM. Failing to identify the second VM, the target VM decision unit 26 notifies the OS 31a in the first VM of an error message.

When notified by the target VM decision unit 26 in the VMM 21 of the error message, the OS 31a in the first VM displays an error message reading, for example, “User ID error or password error” on the corresponded monitor 51a (52a, 53a, or 54a). The authentication UI unit 32a in the first VM displays again the authentication dialog illustrated in FIG. 6 and is ready to receive information for authenticating the user.

If the second VM is identified, the target VM decision unit 26 (authentication request transfer unit) transfers to the authenticating unit 36a in the second VM the user ID and password acquired from the OS 31a in the first VM. The target VM decision unit 26 then requests the authenticating unit 36b in the second VM to authenticate the user ID and password. The authenticating unit 36b in the second VM authenticates the user ID and password acquired from the target VM decision unit 26 and notifies the target VM decision unit 26 in the VMM 21 of the authentication result.

When notified by the authenticating unit 36b in the second VM of the authentication result, the target VM decision unit 26 in the VMM 21 determines whether the authentication result that the user ID and password have been successfully authenticated has been received. If the authentication result that the user ID and password have failed to be authenticated is received, the target VM decision unit 26 notifies the OS 31a in the first VM of an error message. In response to the error message from the target VM decision unit 26, the OS 31a in the first VM displays the error message on the corresponded monitor 51a (52a, 53a, or 54a). The authentication UI unit 32a in the first VM displays again the authentication dialog illustrated in FIG. 6, and is ready to receive information for authenticating the user.

If the authentication result that the user ID and password have been successfully authenticated is received, the target VM decision unit 26 instructs the device switch 23 to assign the input-output device set 51 (52, 53, or 54) used by the user to the second VM. More specifically, the target VM decision unit 26 instructs the device switch 23 to interchange between the input-output device set 51 (52, 53, or 54) corresponded to the first VM and the input-output device set 52 (51, 53, or 54) corresponded to the second VM.

In this way, the input-output device set 51 (52, 53, or 54) used by the user is corresponded to the second VM assigned to the user. After switching the correspondence of between the VMs and the input-output device sets 51, 52, 53, and 54, the target VM decision unit 26 in the VMM 21 instructs the mode switch 34b in the second VM to change the mode from the authentication UI mode to the desktop UI mode. The user can thus start using the VM assigned to them in the desktop UI mode.

After the input-output device set 52 (51, 53, or 54) originally corresponded to the second VM is corresponded to the first VM, the first VM displays the authentication dialog on the corresponded monitor 51a (52a, 53a, or 54a) with the authentication UI unit 32.

The processes of the CPU 1 of the fifth embodiment are identical to the processes of the previously discussed first embodiment except the process of the target VM decision unit 26 and the authenticating unit 36, and the discussion thereof is omitted here.

The process of the CPU 1 in the PC 10 of the fifth embodiment is described below with a flowchart. The process of the CPU 1 performed at the power-on of the PC 10 of the fifth embodiment is identical to the process of the first embodiment described with reference to FIG. 8, and the discussion thereof is omitted here.

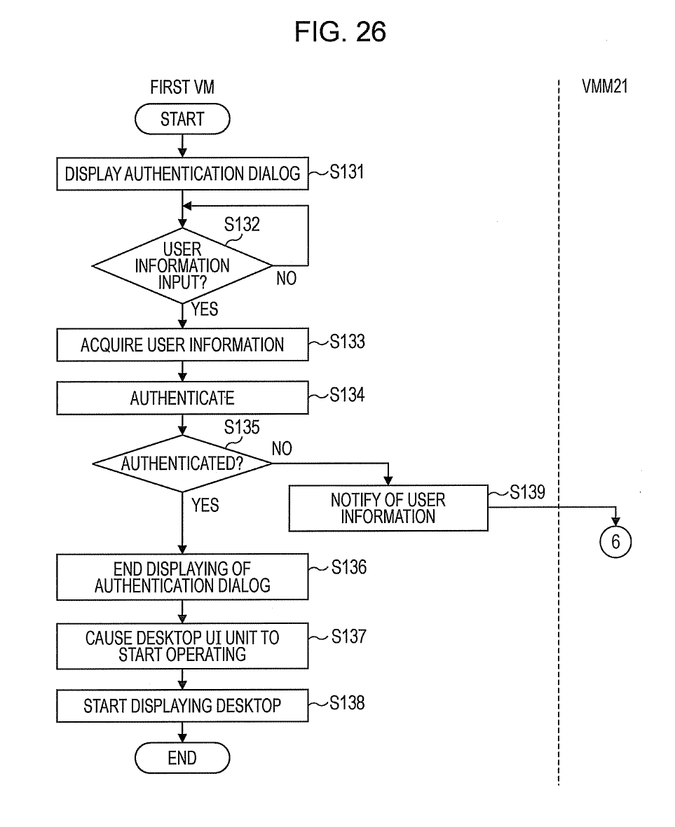

The user may start operating the PC 10 (VM) of the fifth embodiment using the input-output device set 51 (52, 53, or 54) with all the VMs operative. The process of the CPU 1 is described with the flowchart illustrated in FIGS. 26-28. FIGS. 26-28 are the flowchart of a user authentication process. The process of the CPU 1 is executed by the VMM 21 and the VM (OS 31) in accordance with the control program stored on one of the ROM 2 and the HDD 4 in the PC 10.

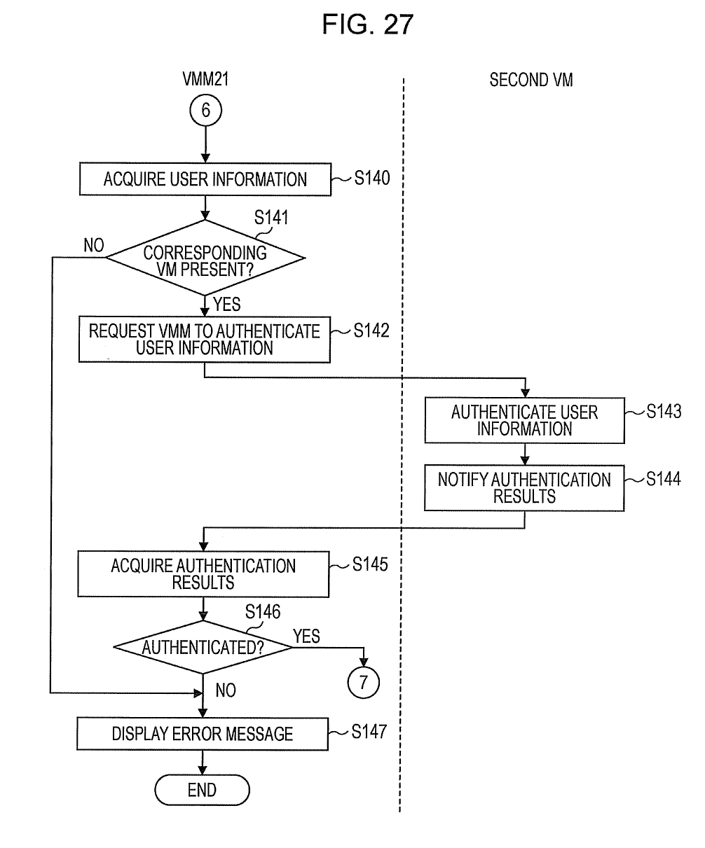

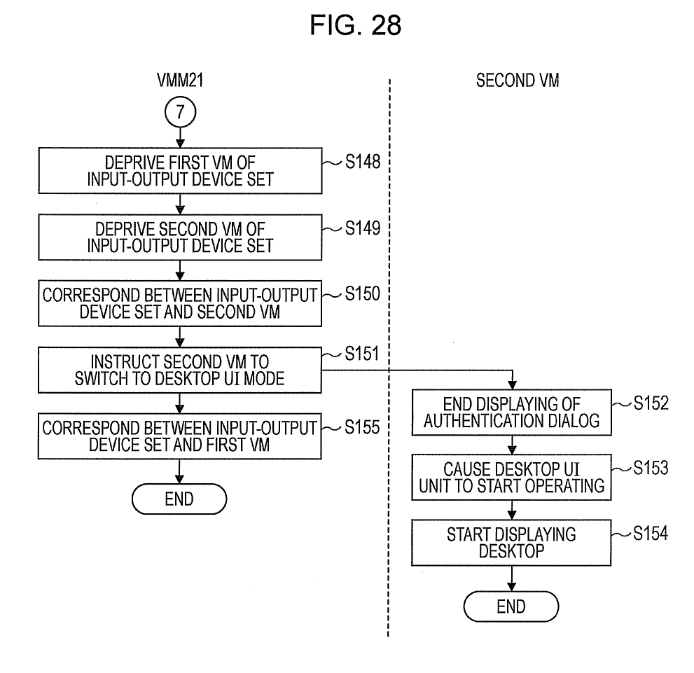

The process performed by the CPU 1 when the user inputs the user ID and password using the input-output device set 51 corresponded to the first VM is described below. The page of FIG. 26 is delineated by a vertically extending broken line into a left-hand side portion and a right-hand side portion. FIG. 26 illustrates a process of the first VM on the left-hand side portion thereof and a process of the VMM 21 on the right-hand side portion thereof. FIGS. 27 and 28 each are delineated by a vertically extending broken line into a left-hand side portion and a right-hand side portion. A process of the VMM 21 is illustrated on the left-hand side portion and a process of the second VM is illustrated on the right-hand side portion in each of FIGS. 27 and 28.

The first VM (OS 31a) started by the VMM 21 displays the authentication dialog illustrated in FIG. 6 on the corresponded monitor 51a (S131). The first VM determines whether the user information (user ID and password) has been input via the corresponded input-output device set 51 (more specifically, the keyboard 51b and the mouse 51c). If it is determined that no user information has been input (NO in S132), the first VM waits on standby. If it is determined that the user information has been input (YES in S132), the first VM acquires the user information (S133).

The first VM authenticates the acquired user information based on the pre-stored user information (S134). If the user information is successfully authenticated (Yes in S135), the authentication dialog displayed in step S131 is discontinued (S136). The first VM causes the authentication UI unit 32a to end the operation thereof and causes the desktop UI unit 35a to start operating (S137). With the desktop UI unit 35a working, the first VM starts displaying the desktop on the corresponded monitor 51a (S138). The first VM ends the above-described user authentication process, and starts operating in the desktop UI mode.

If the user information is not successfully authenticated (NO in S135), the first VM notifies the VMM 21 of the user information acquired in step S133 (S139). The VMM 21 acquires the user information that the first VM has notified of (S140), and determines based on stored content on the VM-user mapping table 4a whether any VM (second VM) corresponded to the user ID contained in the acquired user information is present (S141). If it is determined that any VM corresponded to the user ID is present (YES in S141), the VMM 21 requests the second VM to authenticate the user information acquired in step S140 (S142).

The second VM authenticates the user information based on the pre-stored user information in response to the authentication request from the VMM 21 (S143), and notifies the VMM 21 of the authentication result (S144). The VMM 21 acquires the authentication result from the second VM (S145), and determines whether the acquired authentication result indicates a successful authentication (S146). If the authentication result indicates a failed authentication (NO in S146), or if it is determined in step S141 that no VM corresponding to the user ID is present (NO in S141), the VMM 21 notifies the first VM of an error message (S147), and ends the process.

The first VM notified by the VMM 21 of the error message displays on the corresponded monitor 51a the error message stating that the user information has not been successfully authenticated, and displays again the authentication dialog illustrated in FIG. 6.

If it is determined that the acquired determination result indicates that the user ID has been successfully authenticated (YES in S146), the VMM 21 deprives the first VM of the input-output device set 51 used by the user (S148). The VMM 21 deprives the second VM of the input-output device set 52 assigned to the second VM (S149). The VMM 21 corresponds the input-output device set 51 used by the user to the second VM (S150). In this way, the input-output device set 51 is assigned to the second VM.

The VMM 21 instructs the second VM to change the mode from the authentication UI mode to the desktop UI mode (S151). In response to the instruction from the VMM 21 to change to the desktop UI mode, the second VM ends the displaying of the authentication dialog presented by the authentication UI unit 32a (S152). The second VM causes the authentication UI unit 32b to end the operation thereof and causes the desktop UI unit 35b to start operating (S153). With the desktop UI unit 35b operating, the second VM starts displaying the desktop on the corresponded monitor 51a (S154). The second VM ends the above-described user authentication process and starts operating in the desktop UI mode.

The VMM 21 corresponds between the input-output device set 52, which the VMM 21 has deprived the second VM of, and the first VM (S155), and ends the above-described user authentication process. In this way, the input-output device set 52 is assigned to the first VM and the first VM displays the authentication dialog on the corresponded monitor 52a.

The VM operating in the desktop UI mode driven by the desktop UI unit 35 may receive an instruction to end the operation from the user on the PC 10 of the fifth embodiment. The process performed in this case by the VM is identical to the process of the first embodiment discussed with reference to FIG. 12, and the discussion thereof is omitted here.

The authenticating unit 36 of any one of the VMs authenticates the user information input through the input-output device sets 51, 52, 53, and 54 in the PC 10 of the fifth embodiment. The VM stores, as the system information of the OS 31, the user ID and password of the user to which the VM is assigned, and performs the authentication process on the user using the user ID and password. Since the VM performs the authentication process on the user, the workload on the VMM 21 is reduced.

The PC 10 of the fifth embodiment has been discussed as a modification to the PC 10 of the first embodiment. The structure of the PC 10 of the fifth embodiment is applicable to the PCs 10 of the second through fourth embodiments.

### Sixth Embodiment

A PC of a sixth embodiment is described below. The PC of the sixth embodiment is similar in structure to the PC 10 of the first embodiment. Elements identical to those in the PC 10 of the first embodiment are designated with the same reference numerals and the discussion thereof is omitted here.

Each VM of the first embodiment displays the authentication dialog illustrated in FIG. 6 on the pre-corresponded monitors 51a, 52a, 53a, and 54a of the input-output device sets 51, 52, 53, and 54 in the authentication UI mode. In accordance with the sixth embodiment, the VM operating in the authentication UI mode displays beforehand the user ID of the user corresponded to thereto in an input box of the user ID in the authentication dialog of FIG. 6.

The CPU 1 in the PC 10 of the sixth embodiment performs the functions of FIGS. 4 and 5 by executing the variety of programs stored on one of the ROM 2 and the HDD 4. The authentication UI unit 32 in the VM of the sixth embodiment reads the user ID of the user thereof when the display screen illustrated in FIG. 6 is displayed on the corresponded monitor 51a (52a, 53a, or 54a). It is noted that the user ID of the user pre-corresponded to each VM is stored as the system information of the VM on the HDD 4 or the like on a per OS 31 basis.

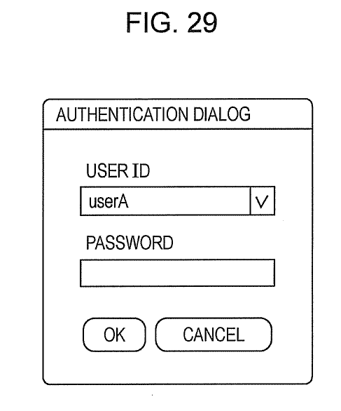

The authentication UI unit 32 (user information notifier) displays on the monitor 51a (52a, 53a, or 54a) corresponded to own VM the read user ID in the authentication dialog displayed on the input box of the user ID. The authentication UI unit 32 thus receives information for authenticating the user. FIG. 29 illustrates the display screen in accordance with the sixth embodiment. The authentication dialog illustrated in FIG. 29 includes two input boxes of the user ID and the password, an OK button, and a cancel button. One user ID is already input to the input box of the user ID.

A pulldown menu is attached to the input box of the user ID in the authentication dialog of the sixth embodiment so that the user ID of each user authorized to use the PC 10 is selected. In the authentication dialog illustrated in FIG. 29, the user identified by the user ID already input to the input box of the user ID simply inputs a password of theirs using the input-output device set 51 (52, 53, or 54) including the corresponded monitor 51a (52a, 53a, or 54a) respectively.

A user other than the users identified by the user IDs input in the input box of the user ID inputs the user ID and password of theirs using the input-output device set 51 (52, 53, or 54) including the corresponded monitor 51a (52a, 53a, or 54a) respectively.

If the OK button is selected in the authentication dialog of FIG. 29 with the user ID and password entered, the authentication UI unit 32 corresponded to the input-output device sets 51, 52, 53, and 54 used by the user acquires the user ID and password.

The processes performed by the CPU 1 of the sixth embodiment are identical to the processes of the first embodiment except the process of the authentication UI unit 32, and the discussion thereof is omitted here.

The process performed by the CPU 1 at the power-on of the PC 10 of the sixth embodiment is identical to the process of the first embodiment discussed with reference to FIG. 8 and the discussion thereof is omitted here. The VM in the PC 10 of the sixth embodiment displays the authentication dialog bearing the user ID of the user of the VM on the corresponded monitor 51a (52a, 53a, or 54a) as illustrated in FIG. 29.

The process of the CPU 1 of the sixth embodiment performed when the user starts operating the PC 10 (VM) using the input-output device set 51 (52, 53, or 54) with all the VM started remains unchanged from the corresponding process of the first embodiment discussed with reference to FIGS. 9-11 and the discussion thereof omitted here. The process of the CPU 1 of the sixth embodiment performed when the user ends the operation of the VM in the desktop UI mode in the PC 10 of the sixth embodiment is identical to the corresponding process of the first embodiment discussed with reference to FIG. 12, and the discussion thereof is omitted here.

In the PC 10 of the sixth embodiment, the VM operating in the authentication UI mode displays the user ID of the user of the VM in the authentication dialog presented on the monitors 51a, 52a, 53a, and 54a corresponded to the VM. The users recognize the user IDs in the authentication dialogs displayed on the monitors 51a, 52a, 53a, and 54a. If the user uses the input-output device set 51 (52, 53, or 54) including the corresponded monitor 51a (52a, 53a, or 54a) displaying the user ID of the user, the switching operation of the correspondence of between the VMs and the input-output device sets 51, 52, 53, and 54 becomes unnecessary. The waiting time until the VM is ready to operate is thus reduced.

The PC 10 of the sixth embodiment has been discussed as a modification to the PC 10 of the first embodiment. The structure of the PC 10 of the sixth embodiment is applicable to the PCs 10 of the second through fifth embodiments.

In accordance with the first through sixth embodiments, the user using the VM inputs the user information using the input-output device sets 51, 52, 53, and 54. The present invention is not limited to such an arrangement. The user may input the user information using an ID card or through voice inputting.

In accordance with the first through sixth embodiments, one VM is assigned to one user. A plurality of VMs may be assigned to one user, or one VM may be assigned to a plurality of users. If one VM is shared by a plurality of users, a plurality of user IDs may be corresponded to one VM-ID on the VM-user mapping table 4a illustrated in FIG. 3A. If a plurality of VMs is assigned to one user, the same user ID is corresponded to a plurality of VM-IDs in the VM-user mapping table 4a illustrated in FIG. 3A. It is noted that if one VM is shared by a plurality of users, the plurality of users are unable to use concurrently the VM.

In the information processing apparatuses of the embodiments disclosed herein, a user can use a virtual machine assigned to the user using any of the input devices.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/ora semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. An information processing apparatus, comprising:
a plurality of executers executing a variety of processes;
a controller controlling operation of each of the plurality of executers; and
a user mapping storage unit that stores correspondence between user information and users respectively corresponded to the executers,
wherein each executer comprises:
a user information storage unit that stores first user information of a user pre-corresponded to the executer;
an input receiving unit that receives second user information from an input unit pre-corresponded to the executer;
a user information acquisition unit that acquires, via the corresponded input unit, the second user information received by the input receiving unit;
a determiner that determines whether the second user information acquired by the user information acquisition unit matches the first user information stored in the user information storage unit;
an operation starting unit that starts a standard operation when the determiner has determined that the second user information acquired by the user information acquisition unit matches the first user information stored in the user information storage unit; and
an identification requesting unit that requests the controller to identify another executer corresponded to the second user information acquired by the user information acquisition unit when the determiner has determined that the second user information acquired by the user information acquisition unit fails to match the first user information stored in the user information storage unit, and
wherein the controller comprises:
an identifying unit that identifies the other executer corresponded to the second user information in accordance with the correspondence stored in the user mapping storage unit when the executer has requested the controller to identify the other executer corresponded to the second user information; and
an interchanging unit that interchanges between the input unit corresponded to the executer having requested the other executer to be identified and the input unit corresponded to the other executer when the identifying unit has identified the other executer.

2. The information processing apparatus according to claim 1, wherein each input receiving unit receives, together with the second user information, authentication information authenticating each user,
wherein each user information acquisition unit acquires the second user information and the authentication information, received by the input receiving unit,
wherein each executer further comprises an authentication requesting unit that requests the controller to authenticate the authentication information acquired by the user information acquisition unit,
wherein the controller further comprises:
an authentication information storage unit that pre-stores the authentication information of each user;
an authentication unit that authenticates the authentication information in response to an authentication request from the executer, based on the authentication information stored on the authentication information storage unit; and
an authentication result notifier that notifies the authentication requesting executer of the authentication result by the authentication unit, and
wherein, when notified by the controller of the authentication result that the authentication information has been authenticated, the determiner in the executer determines whether the second user information acquired together with the authentication information by the user information acquisition unit matches the first user information stored in the user information storage unit.

3. The information processing apparatus according to claim 1, wherein each user information storage unit stores the second user information and authentication information authenticating each user,
wherein each input receiving unit receives the authentication information of each user together with the second user information,
wherein each user information acquisition acquires the second user information and the authentication information, received by the input receiving unit;
wherein each executer further comprises:
an authentication unit that authenticates the authentication information acquired by the user information acquisition unit or the authentication information that the controller has requested the authentication unit to authenticate, in response to the authentication information stored in the user information storage unit;
an authentication requesting unit that requests the controller to authenticate the authentication information when the authentication information acquired by the user information acquisition unit fails to have been authenticated by the authentication unit; and
an authentication result notifier that notifies the controller of the authentication result of the authentication information that the authentication unit has been requested by the controller to authenticate,
wherein each operation starting unit starts the standard operation when the second user information acquired by the user information acquisition unit has been authenticated by the authentication unit;
wherein the controller further comprises:
an authentication executer identifying unit that identifies the other executer in accordance with the correspondence stored in the user mapping storage unit in response to a request from the executer to authenticate the authentication information, the other executer corresponded to the second user information acquired together with the authentication information by the user information acquisition unit in the executer; and
an authentication request transfer unit that requests the other executer identified by the authentication executer identifying unit to authenticate the authentication information, and
wherein each interchanging unit interchanges between the input unit corresponded to the executer having requested the authentication information to be authenticated and the input unit corresponded to the other executer having notified of the authentication result, when the other executer identified by the authentication executer identifying unit has notified the interchanging unit that the authentication information has been authenticated.

4. The information processing apparatus according to claim 1, further comprising:
an input mapping storage unit that stores correspondence between each executer and the input unit corresponded to the respective executer,
wherein the controller further comprises:
a starting unit that starts each executer with the executer corresponded to the input unit satisfying the correspondence stored in the input mapping storage unit.

5. The information processing apparatus according to claim 1, further comprising:
an input-output device mapping storage unit that stores correspondence between each executer and an input-output device operating with the respective executer,
wherein the controller further comprises a mapping control unit that corresponds between the input-output device and the started executer to be used in accordance with the correspondence stored in the input-output device mapping storage unit.

6. The information processing apparatus according to claim 1, wherein the controller further comprises an input information storage unit that stores information being input via the input unit corresponded to the other executer when the interchanging unit switches the input units, and
wherein the input receiving unit in the executer further comprises a notifier that notifies of information stored in the input information storage unit via the input unit corresponded as a result of a switching operation of switching the input units by the interchanging unit.

7. The information processing apparatus according to claim 1, wherein each input receiving unit further comprises a user information notifier that, via the pre-corresponded input unit, notifies of the user information of the user pre-corresponded to own respective executer.

8. An information processing method of an information processing apparatus that includes a plurality of executers executing a variety of processes and a controller controlling operation of each of the executers, the information processing method comprising:
receiving user information from a input unit pre-corresponded to the executer;
acquiring the received user information via the corresponded input unit;
determining whether the acquired user information matches user information of the pre-corresponded user;
starting a standard operation when the acquired user information is determined to match the user information of the pre-corresponded user;
requesting the controller to identify another executer corresponded to the acquired user information when the acquired user information is determined to fail to match the user information of the pre-corresponded user;
identifying the other executer corresponded to the user information when the executer requests the other executer corresponded to the user to be identified; and
switching between the input unit corresponded to the executer having requested the other executer to be identified and the input unit corresponded to the other executer when the other executer is identified.

9. A computer-readable storage medium storing a program, the program causing a computer to function as:
a plurality of executers executing a variety of processes, and a controller controlling operation of each of the executers, the program comprising a first computer program and a second computer program, the first computer program causing the computer to function as the executer, each executer comprising:
an input receiving unit that receives the user information from an input unit pre-corresponded to the executer, a user information acquisition unit that acquires, via the corresponded input unit, the user information received by the input receiving unit, a determiner that determines whether the user information acquired by the user information acquisition unit matches the user information of the pre-corresponded user, an operation starting unit that starts a standard operation when the determiner has determined that the user information acquired by the user information acquisition unit matches the user information of the pre-corresponded user, and an identification requesting unit that requests the controller to identify another executer corresponded to the user information acquired by the user information acquisition unit when the determiner has determined that the user information acquired by the user information acquisition unit fails to match the user information of the pre-corresponded user; and
the second computer program causing the computer to function as the controller, the controller comprising:
an identifying unit that identifies the other executer corresponded to the user information when the executer has requested the controller to identify the other executer corresponded to the user information, and an interchanging unit that interchanges between the input unit corresponded to the executer having requested the other executer to be identified and the input unit corresponded to the other executer when the identifying unit has identified the other executer.
